(19) United States
(12) Patent Application Publication
(10) Pub. No.: US 2026/0218087 A1
(43) Pub. Date: Jul. 30, 2026

(54) ALKOXYLATED NITROGEN CONTAINING POLYMERS AND THEIR USE

(71) Applicant: BASF SE, Ludwigshafen am Rhein (DE)

(72) Inventors: Rainer KLOPSCH, Ludwigshafen (DE); Stephan HUEFFER, Ludwigshafen (DE); Ivette GARCIA CASTRO, Ludwigshafen (DE); Yannick MATT, Ludwigshafen (DE); Jessica Eleanor BEAN, Stockport (GB)

(21) Appl. No.: 19/159,099

(22) PCT Filed: Mar. 5, 2024
(86) PCT No.: PCT/EP24/55702

§ 371 Date: Aug. 22, 2025

(30) Foreign Application Priority Data
Mar. 13, 2023 (EP) 23161587.3

(51) Int. Cl. C11D 3/37; C08G 65/26; C08G 65/48; C11D 3/00; C11D 3/20; C11D 3/33; C11D 3/386; C11D 3/48

(52) U.S. Cl. CPC C11D 3/3723; C08G 65/2624; C08G 65/48; C11D 3/0073; C11D 3/2086; C11D 3/33; C11D 3/386; C11D 3/48; C11D 2111/18

(57) ABSTRACT

Disclosed herein are alkoxylated nitrogen containing polymers that are based on the polymerization of a di- or oligoamine together with a compound including at least two glycidyl ether groups, their manufacture, intermediates and methods of their uses, for example, in laundry or dishwashing applications.

This invention deals with alkoxylated nitrogen containing polymers (in this present invention abbreviated as “inventive polymer” or “polymer of the invention” whenever the inventive polymers are meant), their intermediates, their manufacture, their uses, particularly for use in cleaning compositions such as laundry detergent compositions, and specifically for improved clay removal and/or oily/fatty soil removal in laundry care.

Detergent formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, byproducts of incomplete hydrocarbon combustion, and organic soils like sebum. The removal of greasy (i.e., oily/fatty) stains has been a particularly challenging problem. This challenge has been accentuated by the recent high interest and motivation to reduce the level of surfactants in cleaning detergents for environmental, sustainability and cost reasons. A reduction of the amount of surfactants added, especially a reduction of anionic surfactants, such as linear alkyl benzene sulfonate, LAS, has typically been found to lead to an erosion of oily/fatty stain removal. Additionally, the global trend of using washing conditions at lower temperature further diminishes grease cleaning capabilities of typical detergents, since the class of oily and fatty stains shows the greatest performance drop when the temperature is decreased. On the other hand, clay soil stains, although in some instances contacting the fabric fibers with less force, nevertheless provide a specific type of soil removal problem due to the high degree of charge associated with the clay itself. This high surface charge density may act to repel some laundry ingredients, thus surfactants alone cannot remove or carry away the clay into the laundry liquor.

Another global trend is the compaction of laundry detergents, in order to improve the sustainability in terms of water usage and/or transportation costs, as well as to improve the convenience for the end consumer (e.g., single mono dose products, tabs, pouches and the like), which leads to a high market demand for new raw materials that have a higher weight-efficiency and a significantly broader performance profile.

Thus, new materials should exhibit good soil removal for oily/fatty and particulate stains and should also lead to improved whiteness maintenance, minimizing the amount of suspended and emulsified oily/fatty and particulate soil from redepositing on the surfaces of the textiles or hard surfaces. Preferably, the new ingredients would also display a synergy with other cleaning technologies, such as other cleaning polymers, surfactants and/or enzymes, known for improving solely the oily/fatty or particulate stain removal and/or whiteness of fabrics and hard surfaces, leading to further improved detergent compositions.

Alkoxylated polyalkylene imine polymers, especially the class of alkoxylated hyperbranched polyethylene imine (PEI) and alkoxylated linear polypropylene imine homo- and copolymers, are known in the literature (e.g., EP3301154, EP3167034, EP112593 and WO2020/030469) to be able to contribute to particulate or to oily/fatty soil removal, especially at low surfactant levels and at cold water conditions (30° C. and below). However, their performance is not sufficient, both from a perspective of oily/fatty soil removal capability and also from a perspective of a broader performance profile. Hence, there was a need to find improved polymer architectures with a superior performance profile and a feasible preparation process.

In the following, a summary of the most relevant publications in the field of the present invention, glycidyl ether and amine polymers that are alkoxylated, is given.

U.S. Pat. No. 2,792,367 A discloses polymers synthesized by reacting a monomeric organic non-resinous nitrogen-containing compound and a nonaryl hydrophile polyepoxide. However, in contrast to the polymers of the present invention these polymers are hydrophobic and thus the starter amines contain a different carbon to nitrogen atom ratio of more than four to one as well as a nitrogen mass content of less than 20%. In line with this hydrophobic nature, the polymers of U.S. Pat. No. 2,792,367 A are used for breaking petroleum emulsions, whereas the present polymers are used in cleaning compositions.

U.S. Pat. No. 3,347,803 A relates to polymers prepared of polyamines and polylower alkylene oxide derivatives with halohydrin groups. These polymers are used the preparation of hardenable water-soluble synthetic resinous products and thus differ from the inventive polymers, which are used in detergents. Amongst others, the polymers, for example, differ by their amine to glycidyl ether compound ratio employed to synthesize the respective polymers and also by the arrangement of the functional groups.

A zwitterionic polyamine comprising a crosslinked polyamine backbone is described in WO2001009223 A. However, the amines used together with glycidyl ether compounds for the polymerization contain less than 20% of nitrogen mass content and thus are different from the amines used to prepare the inventive polymers. Further, WO2001009223 A discloses the use of the polymers in laundry detergents, but no experimental data regarding wash performance is provided, let alone any data concerning improvement for soil and/or oily/fatty stain removal. WO2011/035854 A1 discloses alkoxylated cyclic diamines. Comparably, also WO02/68504 A1 relates to polymers that include cyclic structures, such as phenyl groups and derivatives thereof. Due to these cyclic structures these polymers differ from the present polymers by having a hydrophobic nature and different steric properties. These properties are also reflected by the corresponding use of said compounds. The polymers of WO2011/035854 A1 are disclosed in the context of a process for breaking a water-in-oil emulsion, while the polymers of WO02/68504 A1 are described as addition compounds for dispersing solids, especially dyes or pigments. Surprisingly, the present inventors found that the reaction of a di- or oligoamine with a compound comprising at least two glycidyl ether groups and a subsequent alkoxylation reaction results in a polymer that demonstrates superior wash performance on soil and oily/fatty stains compared to reference polymers. The polymers of the present invention gain their superior wash properties by specific parameters employed during their preparation process. The resulting compounds have a core (amine and glycidyl ether groups containing compound) that is not as hydrophobic as described for comparable compounds in the art (see above) and additionally contain a plurality of alkylene oxide branches (“shell”) that are hydrophobic. These characteristics ensure the superior wash properties of the polymers of the present invention.

Thus, the object of the present invention is to provide novel alkoxylated nitrogen containing polymers obtainable by a process comprising the following steps:
a) optionally reaction of (i) at least one di- or polyol with (ii) epichlorohydrin in order to obtain a first intermediate (I1),
b) b) reaction of (i) a di- or oligoamine (A) with (iia) the first intermediate (I1) or (iib) a compound comprising at least two glycidyl ether groups in order to obtain second intermediate (I2), and
c) c) reaction of the second intermediate (I2) with an alkylene oxide (AO) selected from the group consisting of ethylene oxide (EO), propylene oxide (PO) or both and optionally butylene oxide and/or at least one lactone (LA) and/or at least one hydroxy carbon acid (HA), wherein at least 15.0 mol of the alkylene oxide (AO) is employed per mol of NH- and OH-functionality of second intermediate (I2),
   in order to obtain alkylene oxide side chains (AB) linked to nitrogen atoms and —OH groups of the second intermediate (I2) providing the alkoxylated nitrogen containing polymer, wherein the nitrogen mass content of the di- or oligoamine (A) ranges from 20 to 50%.

As described above, the polymer of the invention may be further modified by reactions with alkylene oxides and lactones and/or hydroxy acids to yield alkoxylated nitrogen containing polymers which bear at least one side chain attached to an amino group of the core, i.e. the second intermediate (I2), such side chain comprising at least one alkylene oxide (AO), i.e. ethylene oxide and/or propylene oxide, and, optionally, at least one lactone and/or hydroxy acid per side chain, and/or may be quaternized to introduce non-permanent or permanent quaternization of the amino groups of the core of the inventive polymer.

In the following, any alkylene oxide is generically referred to as “AO”, ethylene oxide is sometimes referred to as “EO”, propylene oxide as “PO”; butylene oxide as “BuO”. “PEO” is used sometimes herein to describe polyethylene oxide homopolymers or PEO-blocks within a larger polymer structure; likewise, “PPO” describes the poly propylene oxide homopolymers or polymer-blocks within a larger polymer structure.

An alkoxylated nitrogen containing polymer with such side chains is sometimes also called a “modified nitrogen containing polymer” within this disclosure to specifically distinguish from an “unmodified nitrogen containing polymer” bearing no such side chains, whereas the term “nitrogen containing polymer” generally herein includes any such nitrogen containing polymers either bearing side chains and/or being quaternized or neither bearing side chains nor being quaternized.

A process to produce the inventive polymers is also part of this invention.

The use of such polymers of this invention for all kinds of applications for which the previously known polyethylene imines, polypropylene imines, comparable polymers and their alkoxylated derivates have been used is encompassed by this present invention as well.

Compositions comprising such alkoxylated nitrogen containing polymers of this invention like those compositions in which the previously known polyethylene imines, polypropylene imines, comparable polymers and their alkoxylated derivates have been employed—either the inventive polymer instead of such known compounds or in combinations with such known compounds—forms part of this invention as well.

The term “polymer”, “polymer of the invention” or “inventive polymer”, as used herein, refers to nitrogen containing polymers prepared as described below and/or in the appended claims. The before terms should be understood broadly, meaning that they encompass the non-alkoxylated (unmodified) nitrogen containing polymers, such as the intermediate described in Embodiment 15, as well as the modified alkoxylated nitrogen containing polymers.

Thus, subjects of the present invention are the following Embodiments 1 to 31 as defined and further explained with further embodiments hereinafter and further exemplified in the experimental section:

### Embodiment 1

An alkoxylated nitrogen containing polymer obtainable by a process comprising the following steps:
a) optionally reaction of (i) at least one di- or polyol with (ii) epichlorohydrin in order to obtain a first intermediate (I1),
b) b) reaction of (i) a di- or oligoamine (A) with (iia) the first intermediate (I1) or (iib) a compound comprising at least two glycidyl ether groups in order to obtain second intermediate (I2), and
c) c) reaction of the second intermediate (I2) with an alkylene oxide (AO) selected from the group consisting of ethylene oxide (EO), propylene oxide (PO) or both and optionally butylene oxide and/or at least one lactone (LA) and/or at least one hydroxy carbon acid (HA), wherein at least 15.0 mol of the alkylene oxide (AO) is employed per mol of NH- and OH-functionality of second intermediate (I2),
   in order to obtain alkylene oxide side chains (AB) linked to nitrogen atoms and —OH groups of the second intermediate (I2) providing the alkoxylated nitrogen containing polymer, wherein the nitrogen mass content of the di- or oligoamine (A) ranges from 20 to 50%.

Within the context of the present invention, the term “NH-functionality” is defined as follows: A primary amino group (—NH2) has two NH-functionalities, a secondary amino group only one NH-functionality, and a tertiary amino group, by consequence, has no reactive NH-functionality. Within the context of the present invention, the term “OH-functionality” is defined as follows: A primary —OH group has one OH-functionality and also a secondary —OH group has one OH-functionality.

The term “alkoxylated”, as used herein, refers to the modification of the second intermediate (I2) with at least 15.0, at least 17.0, at least 20.0, at least 22.0 or at least 25.0 mol ethylene oxide and/or propylene oxide. The resulting structure on the second intermediate (I2) is herein called “alkylene oxide side chain (AB)”. The polymers of the invention may possess only one alkylene oxide side chain (AB), however in more preferable embodiments the inventive polymers possess a plurality of alkylene oxide side chains (AB), such as least 2, at least 5, at least 10 or at least 15. In alternative embodiments, at least 50%, at least 60%, at least 70%, at least 80, at least 90%, at least 95% or even 100% of the NH- and/or OH-functionalities of the second intermediate (I2) are modified with an alkylene oxide side chains (AB).

The term “di- or polyol”, as used herein, refers to compounds that comprise two or more —OH groups. The term “—OH group”, as used herein, refers to hydroxyl groups, in particular alcohol groups. This may also include —OH groups in the context of aromatic structures, such as phenols, however preferred are linear alcohols. The term includes all alcohol groups independent of the status of its carbon atom. Thus, in the sense of the present invention primary, secondary as well as tertiary alcohols fall within the meaning of “—OH group”. Not included within the scope of the term “—OH group” are —OH groups that are part of carboxylic acids. In further preferred embodiments, the di- or polyol contains 2, 3, 4, 5 or 6 —OH groups.

“Epichlorohydrin”, as used herein, refers to a compound which is also known as (Chloromethyl)oxirane, 1-Chloro-2,3-epoxypropane, γ-Chloropropylene oxide, glycidyl chloride or ECH and has the following structure:

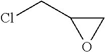

The terms “linked” or “modified”, as used herein, refer to a covalent bond.

“Nitrogen mass content”, as used herein, refers to the ratio of the mass of all nitrogen atoms in the di- or oligoamine (A) relative to the total mass of said di- or oligoamine (A) employed to prepare the inventive polymer. Said nitrogen mass content of the di- or oligoamine (A) may range from 20 to 50%, 21 to 49%, 22 to 48%, 23 to 47%, or 24 to 46%.

The skilled person will also understand that the di- or oligoamines may be pre-polymerized before reacting the resulting polyamine with the compound comprising at least two glycidyl ether groups in order to obtain second intermediate (I2). Subsequently, the second intermediate (I2) can be alkoxylated. As such, the above-described way for synthesising the inventive polymers and the compounds itself fall also within the scope of the invention.

The skilled person may also consider reacting the di- or oligoamine (A) directly with epichlorohydrin. As this reaction may be regarded as an embodiment of the present invention similar to the reaction steps a) and b) described above and thus should also fall within the scope of the present invention.

It is noted that in preferred embodiments, the inventive polymers do no comprise cyclic structures, such as phenyl groups, naphthyl groups, anthryl groups or derivatives thereof.

In preferred embodiments, the molar ratio of the di- or oligoamine to the compound comprising at least two glycidyl ether groups to prepare the inventive polymers ranges from 25:1 to 1:2, preferable from 15:1 to 2:3; from 10:1 to 2:2; or from 5:1 to 2:1.75. Even more preferably, the ratio is 3:1 to 2:1.5 or from 2:1 to 2:1.4.

### Embodiment 2

The alkoxylated nitrogen containing polymer according to Embodiment 1, wherein the at least one di- or oligoamine (A)
(i) has at least 2 amino groups, preferably 2 to 8 amino groups, more preferably 3, 4, 5 or 6 amino groups;
(ii) has at least one carbon atom per nitrogen atom, preferably 1 to 5 carbon atoms per nitrogen atom, more preferably 1 to 3 carbon atoms per nitrogen atom;
(iii) comprises at least two primary and/or secondary amino groups, preferably at least two primary amino groups;
(iv) has a molecular weight (Mw) that lies in the range of 50 to 500 g/mol, preferably in the range of 60 to 300 g/mol, more preferably 80 to 250 g/mol; and/or
(v) is selected from the group consisting of ethylenediamine, hexamethylenediamine, methylcyclohexane diamine (MCDA), propylenediamine (PDA), tetramethylenediamine (TMDA), pentamethylenediamine (PMDA), dipropylene-triamine (DPTA), tripropylene-tetramine (TPTA), tris(2-aminoethyl)amine (TAEA), tetrapropylenpentamin (TPPA), N,N′-Bis-(3-aminopropyl)-ethylenediamine (N4-amine), 3-(2-aminoethylamino)propylamine (N3-amine), spermine, spermidine, triamino nonane, diethylentriamin (DETA), triethylentetramine (TETA), tetraethylenpentamine (TEPA), pentaethylenhexamine (PEHA) and a compounds according to Formulas (II) to (X),

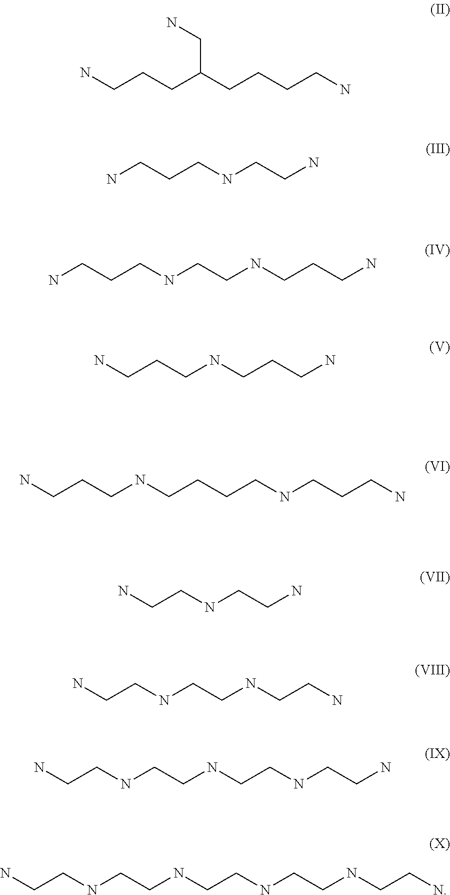

Thus, in preferred embodiments, the di- or oligoamine comprises two or three primary amino groups and in addition 0, 1, 2, 3, 4 or 5 secondary amino groups.

### Embodiment 3

The alkoxylated nitrogen containing polymer according to Embodiment 1 or 2, wherein the compound comprising at least two glycidyl ether groups
(i) comprises at least two times a structure according to formula (I)

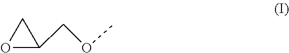

wherein the dotted line indicates bond to the remaining part of the compound comprising at least two glycidyl ether groups, preferably the compound comprising at least two glycidyl ether groups possesses the structure according to formula (I) at least two times; and/or
(ii) is selected from the group consisting of 1,4-butandiol bisglycidyl ether, 1,6-hexanediol bisglycidyl ether, diglycidyl ether, 1,3-neopentylglycol bisglycidyl ether, 1,4-cyclohexanedimethanol bisglycidyl ether, ethylene glycol bisglycidyl ether, glycerin triglycidyl ether and trimethylolpropane triglycidyl ether.
   In preferred embodiments, the compound comprising at least two glycidyl ether groups comprises the structure according to formula (I) 2, 3, 4, 5 or 6 times.

### Embodiment 4

The alkoxylated nitrogen containing polymer according to any of Embodiments 1 to 3, wherein the di- or polyol is selected from the group consisting of 1,4-butandiol, 1,6-hexanediol, 1,3-neopentylglycol, 1,4-cyclohexanedimethanol, glycerin and trimethylolpropane.

### Embodiment 5

The alkoxylated nitrogen containing polymer according to any of Embodiments 1 to 4, wherein the alkoxylated nitrogen containing polymer comprises a structural element according to Formula (XI)

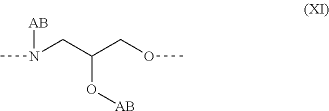

wherein
the dotted lines indicate bonds to the remaining parts of the alkoxylated nitrogen containing polymer; and
AB represent one alkylene oxide side chain.

### Embodiment 6

The alkoxylated nitrogen containing polymer according to any one of Embodiments 1 to 5, wherein the alkoxylated nitrogen containing polymer is
(i) soluble in water; and/or
(ii) a polymer based on a branched second intermediate (I2).

The term “water-soluble”, as used herein in the context of the inventive polymers, refers to solutions of the alkoxylated nitrogen containing polymers which are soluble or miscible in water to provide a solution which is clear at the concentration employed. More preferably, the polymers of the invention are water-soluble in a temperature range from 15 to 30° C., preferably in a range from 20 to 25° C. or more preferably at room temperature.

The term “branched”, as used herein, in relation to the inventive polymers refers to its definition as known to those of skill in the art. A branched polymer comprises generally polydisperse branched macromolecules which are preferably prepared in a single synthetic polymerization step that forms imperfect branches, generally in a non-deterministic way. However, there are many preferable synthetic strategies known in the art to prepare branched polymers with lower polydispersity. They are typically characterized by their degree of branching (DB). The branched polymer of the invention may comprise tertiary, secondary, and primary amines before being alkoxylated, in which case the primary amines might as an example be converted to secondary and/or tertiary amines and secondary amines might, for example, be converted to tertiary amines, leading to the same imperfect branched structure. The term degree of branching (DB) has a meaning known in the field of branched macromolecules and its use herein is consistent with that meaning. A preferable definition is provided, for example, in C. J. Hawker, R. Lee, and J. M. J. Fréchet (1991), “The One-Step Synthesis of Hyperbranched Dendritic Polyesters,” J. Am. Chem. Soc., 113: 4583, which is incorporated herein by reference in its entirety.

In principle, the inventive polymers may be linear or branched, but preferably they are branched. The polymers of the present invention are branched with the branching forming a tertiary amino group, wherein branches may be relatively short alkylene amino groups as such (e.g., —(CH2)3-NH2 groups) up to very long side chains which may contain further amino-groups being similarly branched etc, thus leading to branched structures.

By consequence, the inventive polymers have a basic skeleton (backbone, i.e., intermediate 12), which comprises primary, secondary and tertiary nitrogen atoms and —OH groups which are joined by i) alkylene or ii) any substituted or non-substituted linear or branched alkyl radicals (depicted as R):
primary amino moieties terminate the main and also the side chains of the basic skeleton and whose hydrogen atoms may be subsequently replaced by side chains when modified with alkylene oxides:

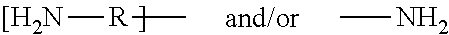

secondary amino moieties whose hydrogen atom may be subsequently replaced by side chains when modified with alkylene oxides:

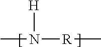

tertiary amino moieties which branch the main chain and the side chains:

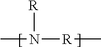

and optionally

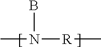

For the sake of completeness, it is indicated that the variable B indicating the branching of the polymer backbone containing at least one fragment with at least one further amino moiety including a two times, three times or even higher degree of branching. The degree of branching may be determined, for example, by NMR-spectroscopy such as ¹H-NMR or preferably ¹³C-NMR spectroscopy.

In preferred Embodiments, the backbone-modified polymers comprise a plurality of primary, secondary and tertiary amino groups, whereas the backbone of the modified branched alkoxylated polymers comprises mainly tertiary amino groups. The amine number for primary, secondary, and tertiary amines is determined in accordance with the standard DIN EN ISO 9702.

### Embodiment 7

The alkoxylated nitrogen containing polymer according to any of Embodiments 1 to 6, wherein the weight average molecular weight (Mw) of the alkoxylated nitrogen containing polymer lies in the range of 500 to 150 000 g/mol, preferably in the range of 1500 to 75 000 g/mol, more preferably in the range of 2000 to 50 000 g/mol.

In preferred embodiments, the lower limit of the weight average molecular weight (Mw) of the alkoxylated nitrogen containing polymer is 500, 1000, 1500, 2000, 2500 or 3000 g/mol. In alternative embodiments, the upper limit of the weight average molecular weight (Mw) of the alkoxylated nitrogen containing polymer is 150 000, 125 000, 100 000, 80 000, 75 000, 70 000, 60 000 or 50 000 g/mol.

Molecular weights of the alkoxylated nitrogen containing polymers can be determined by gel permeation chromatography (GPC). The GPC measurements can be carried out on a column combination of three following columns: HFIP-LG Guard, PL HFIPGEL and PL HFIPGel using Hexafluorisopropanol+0.05% Trifluoracetic-acid salt as mobile phase and polyethylene glycol standards from the company Polymer Laboratories (with molecular weights from M=194 to M=22.800). The used detector may be a DRI Agilent 1100. “Mw” is the weight average molecular weight and “Mn” is number average molecular weight.

The respective values of Mw and/or Mn can be determined as described within the experimental section below.

The molar mass distribution Mw/Mn obtained by GPC is equal to the polydispersity index (PDI), the PDI being without unit [g/mol/g/mol]).

### Embodiment 8

The alkoxylated nitrogen containing polymer according to any one of Embodiments 1 to 7, wherein up to 50% of the nitrogen atoms present in the alkoxylated nitrogen containing polymer are further quaternized, preferably the degree of quaternization of the nitrogen atoms present in the alkoxylated nitrogen containing polymer lies in the range of 0.5% to 25%.

It is well-known to a person of skill in the art that polyamines structures in general and such structures of the inventive polymers can be quaternized using standards means, due to their in principle chemical similarity with already known structures of this general type, and the known ability to modify those known structures by quaternization.

Clearly, also the present structures described herein as alkoxylated nitrogen containing polymers can be quaternized as well.

A suitable degree of quaternization is in the range of 0.1 to 50%, preferably 0.5 to 25% or more preferably 1 to 20%. The quaternization is conducted preferably by introducing C1-C22-alkyl groups, C1-C4-alkyl groups and/or C7-C22-aralkyl groups and may be undertaken in a customary manner by reaction with corresponding alkyl-, aralkyl-halides and dialkylsulfates, as described for example in WO 09/060059.

The quaternization may be advantageous in order to adjust the inventive polymer to the particular composition such as laundry compositions in which they are to be used, and to achieve better compatibility and/or phase stability of the formulation.

Quaternization can be accomplished, for example, by reacting an inventive polymer with an alkylation agent such as a C1-C4-alkyl halide, for example with methyl bromide, methyl chloride, ethyl chloride, methyl iodide, n-butyl bromide, isopropyl bromide, or with an aralkyl halide, for example with benzyl chloride, benzyl bromide or with a di-C1-C22-alkyl sulfate in the presence of a base, especially with dimethyl sulfate or with diethyl sulfate. Suitable bases are, for example, sodium hydroxide and potassium hydroxide.

The amount of alkylating agent determines the amount of quaternization of the amino groups in the polymer, i.e., the amount of quaternized moieties.

The amount of the quaternized moieties can be calculated from the difference of the amine number in the non-quaternized amine and the quaternized amine. The amine number can be determined according to the method described in DIN 16945.

The quaternization can be carried out without any solvent. However, a solvent or diluent like water, acetonitrile, dimethylsulfoxide, N-methylpyrrolidone, etc. may be used. The reaction temperature is usually in the range from 10° C. to 150° C. and is preferably from 50° C. to 100° C.

### Embodiment 9

The alkoxylated nitrogen containing polymer according to any of Embodiments 1 to 8, wherein i) the lactone (LA) is selected from the group consisting of caprolactone, g- or d-valerolactone, and lactide, and/or ii) the hydroxy carbon acid (HA) is selected from the group consisting of lactic acid and glycolic acid.

The introduction of lactones (LA) and hydroxy carbon acids (HA) is disclosed in WO2021/165468 A, WO2021/165493 A, WO2022/136408 A, WO2023/021105 A and WO2023/021104 A and it has been demonstrated that such modifications of the alkoxy side chains will only mildly influence the wash performance of the polymer but on the other hand will significantly impact the biodegradation of the shell, namely the alkoxy side chains. Aerobic biodegradation in wastewater may be measured according to OECD 301 F and is expressed as a percentage of the theoretical oxygen demand (ThOD, which is measured by the elemental analysis of the compound of interest), which is needed to completely biodegrade the polymer sample. Thus, the amount of oxygen taken up by the microbial population during biodegradation of the test substance (corrected for uptake by blank inoculum, run in parallel) is expressed as a percentage of ThOD. The obtained values are preferably measured in triplicate using the OECD 301F manometric respirometry method. The consumption of oxygen may be determined by measuring the change in pressure in the apparatus using an OxiTop® C (Xylem 35 Analytics Germany Sales GmbH & Co KG).

### Embodiment 10

The alkoxylated nitrogen containing polymer according to any of Embodiments 1 to 9, wherein
i) in step c) in total 5 to 100 mol, preferably 10 to 80 mol, more preferably 12 to 60 mol, most preferably 15 to 40 mol of alkylene oxide (AO) is employed per mol of NH- and OH-functionality of second intermediate (I2), wherein more than 50 mol %, preferably more than 85 mol % of the alkylene oxide is based on ethylene oxide, or
ii) in step c) in total 25 to 120 mol, preferably 30 to 110 mol, more preferably 35 to 100 mol, most preferably 40 to 90 mol of alkylene oxide (AO) is employed per mol of NH- and OH-functionality of second intermediate (I2), whereas less than 80 mol %, preferably less than 65 mol % of the alkylene oxide is based on ethylene oxide.

In preferred embodiments of alternative i), more than 50 mol %, more than 60 mol %, more than 70 mol %, more than 80 mol %, more than 90 mol %, more than 95 mol % of the alkylene oxide is based on ethylene oxide.

In preferred embodiments of alternative ii), less than 80 mol %, less than 75 mol %, less than 70 mol %, less than 65 mol %, less than 60 mol %, less than 50 mol % of the alkylene oxide is based on ethylene oxide.

The polymers of the invention may comprise side chains which are attached to nitrogen atoms and previous —OH groups of said polymer. The side chains are made up from ethylene or propylene oxide and optionally C4-C12-alkylene oxides, lactones and/or hydroxy carbon acids. Typically, a side chain comprises ethylene oxide and optionally propylene oxide on the terminal part of the alkylene oxide side chain. The reaction to prepare a side chain comprising AO, LA and HA is—by way of example for the preparation of the side chains in general—typically done by reacting the second intermediate (I2) with the at least one AO and the at least one LA and/or HA in a stepwise manner. However, it is also possible to use mixtures of the AO and LA and/or HA. By adding mixtures of all ingredients at the very same time or by adding the different ingredients at least shortly after each other with a preferably as short as possible time-lag, before the conversion of all monomers has been completed, random copolymer side chains are being formed that are attached to the nitrogen atoms and —OH groups of the backbone.

If a combination of stepwise addition and addition of mixtures is applied, random copolymer chains with inherent block sequences are being formed.

Preferably, a side chain comprises more than 15, more preferably more than 17, even more preferably more than 20 units per NH- and OH-functionality of the inventive polymer stemming from AO, and optionally at least 1 unit per NH- and OH-functionality stemming from LA and/or HA and/or another alkylene oxide. All such numbers are numbers “on average” meaning that such numbers refer to the average number for such unit per NH- and OH-functionality calculated based on all NH- and OH-functionalities of the second intermediate (I2).

It is to be emphasized that the reactions leading to the inventive polymers are statistical reactions, meaning there is never just one chemically exactly defined compound present, but an inventive polymer always is a mixture of slightly deviating structures, all stemming from the same reaction within one reaction space; the difference of those structures clearly stemming from the facts that no reaction proceeds in exactly the same way and the same speed on all functional units, especially as the chemical reactivities of the functional units—here mainly those of the NH- and OH-functionalities, differs according to their environment, meaning that a primary amino group reacts differently than a secondary amine (specifically in terms of reaction with a lactone and/or a hydroxy carbon acid, as described above), and also the chemical environment of the groups may be different in the monomers employed; this leads in an overall view to slightly deviating structures being present, and thus any polymer of this invention being defined as in the various embodiments including the numbered Embodiments 1 to 31, and exemplified in the examples never is just one chemical compound, but always a mixture of slightly deviating compounds, having a statistical distribution. As the reactivities of those groups are not differing by a large extent, the deviation is relatively small. Hence, defining a polymer of the invention by their monomers is a viable way of defining the structures. Also, defining the composition of the side chains by average numbers (including those variables defined in the present and following Embodiments based on the numbers of NH- and OH-functionalities being present in the second intermediate (I2)—such number of functionalities being themselves an average number due to this factual mixture—is a useful way of defining the overall composition of any mixture herein defined as “alkoxylated nitrogen containing polymers of the invention”. Therefore, unless otherwise indicated, the values, ranges and ratios given in the specification for n, the number of NH- and OH-functionalities, and the molecular weight (Mn) relate to the number average values of the mixture obtained as the inventive polymers containing individual, slightly from each other deviating chemical structures of several polymer-compounds, with “alkoxylated nitrogen containing polymer” defining this mixture being the result from the preparation method. As known in polymer science, the weight-average molecular weight (Mw) is then a measure for the (in)homogeneity within the mixture of different species in “alkoxylated nitrogen containing polymer”.

It is noted that the alkylene oxide used to prepare the inventive polymer may be derived from a fossil or non-fossil carbon source or even a mixture of the before mentioned. Preferably, the amount of non-fossil carbon atoms in the alkoxy side chains is at least 10%, at least 20%, at least 40%, at least 70%, at least 95% or it solely comprises non-fossil derived carbon atoms. The skilled person is well-aware of commercial alkylene oxide products made of non-fossil carbon sources (these products are often sold as being sustainable, renewable or bio-based). For example, Croda International, Snaith, UK, sells ethylene oxide and related products based on bio-ethanol as ECO Range. Additionally, methods to prepare bio-based propylene oxide are also known (see Abraham, D. S., “Production of propylene oxide from propylene glycol” Master's Thesis University of Missouri-Columbia (2007) (75 pages)).

### Embodiment 11

The alkoxylated nitrogen containing polymer according to any of Embodiments 1 to 10, wherein
(1) in step b) the di- or oligoamine (A) is methylcyclohexane diamine (MCDA) and the compound comprising at least two glycidyl ether groups is 1.4-butandiol bisglycidyl ether; and
   in step c) at least 25 mol of ethylene oxide and optionally at least 16 mol of propylene oxide is employed per mol of NH- and OH-functionality of second intermediate (I2); or
(2) in step b) the di- or oligoamine (A) is 3-(2-aminoethylamino)propylamine (N3-amine) and the compound comprising at least two glycidyl ether groups is 1,4-butandiol bisglycidyl ether; and
   in step c) at least 20 mol of ethylene oxide and optionally at least 3 mol of propylene oxide is employed per mol of NH- and OH-functionality of second intermediate (I2); or
(3) in step b) the di- or oligoamine (A) is N,N′-Bis-(3-aminopropyl)-ethylenediamine (N4-amine) and the compound comprising at least two glycidyl ether groups is 1,4-butandiol bisglycidyl ether or 1,6-hexanediol bisglycidyl ether; and
   in step c) at least 20 mol of ethylene oxide and optionally at least 24 mol of propylene oxide is employed per mol of NH- and OH-functionality of second intermediate (I2); or
(4) in step b) the di- or oligoamine (A) is triethylentetramine (TETA) and the compound comprising at least two glycidyl ether groups is 1,4-butandiol bisglycidyl ether; and
   in step c) at least 30 mol of ethylene oxide and optionally at least 30 mol of propylene oxide is employed per mol of NH- and OH-functionality of second intermediate (I2); or
(5) in step b) the di- or oligoamine (A) is tris(2-aminoethyl)amine (TAEA) and the compound comprising at least two glycidyl ether groups is 1,6-hexanediol bisglycidyl ether; and
   in step c) at least 25 mol of ethylene oxide and optionally at least 16 mol of propylene oxide is employed per mol of NH- and OH-functionality of second intermediate (I2); or
(6) in step b) the di- or oligoamine (A) is diethylentriamin (DETA) and the compound comprising at least two glycidyl ether groups is 1,6-hexanediol bisglycidyl ether, 1,3-neopentylglycol bisglycidyl ether or 1,4-cyclohexanedimethanol bisglycidyl ether; and
   in step c) at least 20 mol of ethylene oxide and optionally at least 16 mol of propylene oxide is employed per mol of NH- and OH-functionality of second intermediate (I2); or
(7) in step b) the di- or oligoamine (A) is triamino nonane and the compound comprising at least two glycidyl ether groups is 1,4-butandiol bisglycidyl ether; and
   in step c) at least 25 mol of ethylene oxide and optionally at least 16 mol of propylene oxide is employed per mol of NH- and OH-functionality of second intermediate (I2); or
(8) in step b) the di- or oligoamine (A) is tetraethylenpentamine (TEPA) and the compound comprising at least two glycidyl ether groups is 1,4-butandiol bisglycidyl ether or diglycidyl ether; and
   in step c) at least 20 mol of ethylene oxide and optionally at least 20 mol of propylene oxide is employed per mol of NH- and OH-functionality of second intermediate (I2); or
(9) in step b) the di- or oligoamine (A) is pentaethylenhexamine (PEHA) and the compound comprising at least two glycidyl ether groups is 1,4-butandiol bisglycidyl ether or ethylene glycol bisglycidyl ether; and
   in step c) at least 25 mol of ethylene oxide and optionally at least 24 mol of propylene oxide is employed per mol of NH- and OH-functionality of second intermediate (I2).

### Embodiment 12

The alkoxylated nitrogen containing polymer according to any of Embodiments 1 to 11, wherein at least 50%, preferably at least 60% and most preferably at least 80%, even more preferably at least 90, and most preferably at least 95% of all NH- and OH-functionalities of the intermediate (12) are alkoxylated.

Without wishing being bound by the following explanation, a rationale exists to explain the resulting structures of the inventive polymers: Due to the fact that the reactions in questions necessarily employed to prepare a specific structural order of the side chains, and thus to prepare the specific inventive polymers, are reactions of quite reactive species which can lead under suitable conditions to almost complete and even “essentially complete” conversions of almost 100% if not even 100%, for each step of the inventive process, the statistical deviation of the composition of the mixture of “the alkoxylated nitrogen containing polymer” in question is not that high, which in turn means that the structural order of the side chains do not show much deviation. Thus, it is a reliable assumption which can in principle be proven by sophisticated and thus time-consuming and expensive analytical means—such as multi-dimensional NMR-analyses—that it is generally accepted that such deviation exists; hence, no “specific alkoxylated nitrogen containing polymer” will be “just one chemical compound of a clearly defined chemical structure”, but clearly will consist of a a) mixture of slightly differing compounds, such differences lying in b) slight deviations already in the structure of compound making up the second intermediate (I2) being employed for the further modification steps, and c) the slight deviations in the structural orders of the side chains attached by way of d) multi-step reactions due to e) variations in the chemical reactivities of the NH- and subsequently formed OH-functionalities, f) slight differences in the reactivities of employed AO, LA and HA due to their structure and g) due to their reactivities towards the slightly differing reactivities NH- and subsequently formed OH-functionalities, and h) due to slight inhomogeneities occurring in a commercial scale process. All of those factors a) to h)—to just mention a few important ones—lead to a “specific alkoxylated nitrogen containing polymer” which is not one specific chemical compound but in fact a mixture of slightly differing compounds having an overall very similar chemical structure; thus, such structure is best described by average numbers for the variables and percentages for the amounts of the dominating structural order.

### Embodiment 13

A process to prepare an alkoxylated nitrogen containing polymer according to any one of Embodiments 1 to 12 comprising carrying out the process steps according to any one of Embodiments 1 to 12.

In particular, the process comprises the following steps:
a) optionally reaction of (i) at least one di- or polyol with (ii) epichlorohydrin in order to obtain a first intermediate (I1),
b) reaction of (i) a di- or oligoamine (A) with (iia) the first intermediate (I1) or (iib) a compound comprising at least two glycidyl ether groups in order to obtain second intermediate (I2), and
c) reaction of the second intermediate (I2) with an alkylene oxide (AO) selected from the group consisting of ethylene oxide (EO), propylene oxide (PO) or both and optionally butylene oxide and/or at least one lactone (LA) and/or at least one hydroxy carbon acid (HA), wherein at least 15.0 mol of the alkylene oxide (AO) is employed per mol of NH- and OH-functionality of second intermediate (I2),
   in order to obtain alkylene oxide side chains (AB) linked to nitrogen atoms and —OH groups of the second intermediate (I2) providing the alkoxylated nitrogen containing polymer,
   wherein the nitrogen mass content of the di- or oligoamine (A) ranges from 20 to 50%.

All of the terms within Embodiment 13 have already been defined and explained in detail herein before within the description of the Embodiments 1 to 12, such terms and definitions of course apply to this Embodiment 13.

The conversion rate of each reaction step may be monitored: Only when the previous reaction has proceeded to a conversion rate of at least 90%, preferably at least 95%, more preferably at least 99%, and even more preferably at least 99.5% or even more has been achieved, the next reactant may be added which in turn is also monitored for its conversion rate to detect when this next reaction has proceeded to a conversion rate of at least 90%, preferably at least 95%, more preferably at least 99%, and even more preferably at least 99.5% or even more has been achieved, then the even next reaction is to be added—and so on until all reactants have been reacted and the reaction of the last reactant added has proceeded to a conversion rate of at least 90%, preferably at least 95%, more preferably at least 99%, and even more preferably at least 99.5% or even more has been achieved. All other structural orders of the side chains as defined above but also the undefined structures resulting from non-controllable parameters are performed in this defined manner, leading—on statistical average—to a defined structural order directly derived from the way such a stepwise reaction is performed.

The conversion rate of each of the respective steps can be determined according to methods known to the skilled person, such as NMR-spectroscopy, such as 13C-NMR-spectroscopy and/or 1H-NMR-spectroscopy.

For the reaction conditions such as catalysts, temperatures, duration, purification etc. of the reactions to produce the units of the side chains of the inventive polymers, the respective information within the disclosures WO 2021/165468, WO2021/165493 A, WO2022/136408 A, WO2023/021105 A and WO2023/021104 A is fully encompassed into this recent disclosure by way of reference.

Within this preferred embodiment, the alkoxylation is carried out in the presence of at least one catalyst and/or in the absence of water. Within this single step reaction of the alkoxylation step, the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C1-C4-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, a particular preference being given to potassium hydroxide and sodium hydroxide. Typical use amounts for the base are from 0.05 to 10% by weight, in particular from 0.5 to 2% by weight, based on the total amount of the second intermediate (I2) and alkylene oxide.

### Embodiment 14

Process according to Embodiment 13, wherein the alkoxylated nitrogen containing polymer is further submitted to the following process steps of
a) quaternization using standard means, including protonation by pH-adjustment or permanent quaternization by standard means such as alkylation using standard reactants, preferably by alkylation, wherein up to 50% of the nitrogen atoms present in the alkoxylated nitrogen containing polymer are quaternized, preferably the degree of quaternization of the nitrogen atoms present in the alkoxylated nitrogen containing polymer lies in the range of 0.5% to 25%; and/or
b) purification using standard means such as steam distillation, thermal distillation, vacuum evaporation, including removal of all solvent, dialysis and/or
c) drying using standard drying means such as spray-, drum, paddle-, vacuum-drying means including agglomeration methods such as fluidized-bed-drying,
   to obtain a purified (quaternized) polymer solution, a purified liquid (quaternized) polymer, a solid, e.g., granulated or co-granulated (quaternized) polymer or a purified solid (quaternized) polymer, respectively.

In case that after the reaction leading to the inventive polymer residual monomers are present to a non-desirable extent, the resulting product mixture containing the inventive polymer may be further purified by standard means to reduce the content of residual monomers, but also to reduce the amount of possible by-products, reduce the amount(s) of the solvent(s) employed (i.e., to concentrate) or replace solvent(s) with other solvents. Such processes are known to a person of skill in this field.

Preferably, undesirable amounts of residual non-reacted monomers are removed, preferably by means of distillative processes, more preferably by thermal distillative processes, which may additionally comprise the application of reduced pressure to increase the speed and/or the effectiveness of the removal.

In a preferred embodiment only the additional process step b) is employed (in a more preferably embodiment the additional process step b) is employed in reaction step b) and/or c) of Embodiment 13).

### Embodiment 15

A compound that is the second intermediate (I2) according to Embodiment 1, step b).

In detail, said compound is obtainable by a process comprising or consisting of the step:
a) optionally reaction of (i) at least one di- or polyol with (ii) epichlorohydrin in order to obtain a first intermediate (I1), and
b) reaction of (i) a di- or oligoamine (A) with (iia) the first intermediate (I1) or (iib) a compound comprising at least two glycidyl ether groups in order to obtain second intermediate (I2).

All of the terms within Embodiment 15 have already been defined and explained in detail herein before within the description of the Embodiments 1 to 12, such terms and definitions of course apply to this Embodiment 15.

In particular, the at least one di- or oligoamine (A)
(i) has at least 2 amino groups, preferably 2 to 8 amino groups, more preferably 3, 4, 5 or 6 amino groups;
(ii) has at least one carbon atom per nitrogen atom, preferably 1 to 5 carbon atoms per nitrogen atom, more preferably 1 to 3 carbon atoms per nitrogen atom;
(iii) comprises at least two primary and/or secondary amino groups, preferably at least two primary amino groups;
(iv) has a molecular weight (Mw) that lies in the range of 50 to 500 g/mol, preferably in the range of 60 to 300 g/mol, more preferably 80 to 250 g/mol; and/or
(v) is selected from the group consisting of ethylenediamine, hexamethylenediamine, methylcyclohexane diamine (MCDA), propylenediamine (PDA), tetramethylenediamine (TMDA), pentamethylenediamine (PMDA), dipropylene-triamine (DPTA), tripropylene-tetramine (TPTA), tris(2-aminoethyl)amine (TAEA), tetrapropylenpentamin (TPPA), N,N′-Bis-(3-aminopropyl)-ethylenediamine (N4-amine), 3-(2-aminoethylamino)propylamine (N3-amine), spermine, spermidine, triamino nonane, diethylentriamin (DETA), triethylentetramine (TETA), tetraethylenpentamine (TEPA), pentaethylenhexamine (PEHA) and a compounds according to Formulas (II) to (X),

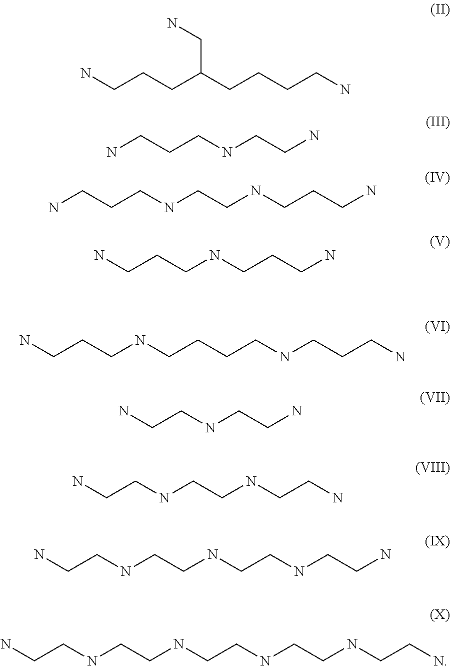

Thus, in preferred embodiments, the di- or oligoamine comprises two or three primary amino groups and in addition 0, 1, 2, 3, 4 or 5 secondary amino groups.

Also in particular, the compound comprising at least two glycidyl ether groups
(i) comprises at least two times a structure according to formula (I)

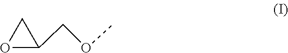

wherein the dotted line indicates bond to the remaining part of the compound comprising at least two glycidyl ether groups, preferably the compound comprising at least two glycidyl ether groups possesses the structure according to formula (I) at least two times; and/or
(ii) is selected from the group consisting of 1,4-butandiol bisglycidyl ether, 1,6-hexanediol bisglycidyl ether, diglycidyl ether, 1,3-neopentylglycol bisglycidyl ether, 1,4-cyclohexanedimethanol bisglycidyl ether, ethylene glycol bisglycidyl ether, glycerin triglycidyl ether and trimethylolpropane triglycidyl ether.

In preferred embodiments, the compound comprising at least two glycidyl ether groups comprises the structure according to formula (I) 2, 3, 4, 5 or 6 times.

In other preferred embodiments, the second intermediate (I2) comprises two structural elements according to Formula (XII)

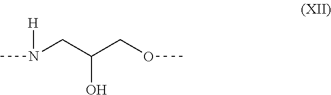

wherein the dotted lines indicate bonds to the remaining parts of the second intermediate (I2) according to Embodiment 1, step b).

Use of and compositions comprising the inventive alkoxylated nitrogen containing polymers Part of this invention is also the use of the inventive alkoxylated nitrogen containing polymers for various fields of applications, where they can replace currently known similar structures, but bring in their enhanced rate of biodegradation compared to those previously known structures.

### Embodiment 16

Use of at least one alkoxylated nitrogen containing polymer according to any one of Embodiments 1 to 12 or producible or produced by a process according to any of Embodiments 13 to 14 in
a) cleaning compositions, preferably as additive for liquid, solid or semi-solid detergent formulations, particularly for liquid detergent formulations, preferably concentrated liquid detergent formulations or single mono doses laundry detergent formulations, or liquid hand dish washing detergent formulations or solid automatic dish washing formulations;
b) in fabric and home care products,
c) in formulations for electro plating;
d) in cementitious compositions;
e) in agrochemical formulations, preferably as dispersant;
f) as adhesion promoters, for example for printing inks for laminate films;
g) as an assistant (adhesion), for example for production of multilayer composite films, with compatibilization not just of different polymer layers but also of metal foils;
h) as adhesion promoters for adhesives, for example in conjunction with polyvinyl alcohol, butyrate and acetate and styrene copolymers, or as a cohesion promoter for label adhesives;
i) as a primer in coatings applications for improvement of adhesion on substrates such as glass, wood, plastic and metal;
j) for improvement of wet adhesion, for example in standard emulsion paints, and for improvement of instantaneous rain resistance of paints, for example for road markings;
k) as complexing agents, especially with high binding capacity for heavy metals such as Hg, Pb, Cu, Ni;
l) as a flocculant, for example in water treatment/water processing;
m) as a penetration aid, for example for active metal salt formulations in wood protection;
n) as corrosion inhibitors, for example for iron and nonferrous metals, and in the sectors of petroleum production and of secondary oil production;
o) for immobilization of proteins and enzymes; microorganisms or as immobilizing supports of enzymes and microorganisms;
p) for blocking and sealing, for example mineral oil and natural gas industry;
q) as fixatives, for example in the textile industry, especially as formaldehyde-free cofixers:
r) as an additive in the cosmetic formulations, for example for hair-setting compositions and hair rinses;
s) as an assistant in the papermaking industry, for example for acceleration of dewatering, elimination of contraries, neutralization of charge and paper coating as a multipurpose assistant;
t) for separation of oil and water, for example in the metalworking industry;
u) as an additive for landfill seals;
v) as a flocculant;
w) as a swimming pool algicide;
x) for production of bitumen chemicals by reaction with fatty acids;
y) as an anti-swelling agent in order that clay absorbs water in a retarded manner;
z) as an emulsifier or emulsion breaker;
aa) as a surfactant in the industrial cleaning (IC) sector;
bb) as a wood protector;
cc) for preparation of complexing agents (polycarboxylates);
dd) for production of assistants for ore mining and mineral processing;
ee) as a dispersant for pigments, ceramic, carbon black, carbon, carbon fibers, metal powders, such as emulsifier or dispersant for inks for e.g. ink jet printing;
ff) for gas scrubbing as an absorbent of CO2, NOX, SOX, Cl2 and aldehydes, and for neutralization of acidic constituents;
gg) for water softening;
hh) as a crystallization inhibitor in e.g. agrochemical formulations, oil-field uses;
ii) as a rheology modifier (thickener);
jj) as an assistant or as a component for assistants for the extraction and processing of oil, coal and natural gas;
kk) for production of synthetic rubber and rubber chemicals;
ll) as an additive in coolants, lubricants and cooling lubricants;
mm) as assistants in the construction chemicals sector;
nn) as a constituent of galvanizing baths; or
oo) for production of nonviral gene vectors.

A subject matter of the present invention is the use of the above-mentioned alkoxylated nitrogen containing polymers in fabric and home care products, in cosmetic formulations, as crude oil emulsion breaker, in pigment dispersions for ink jet inks, in formulations for electro plating, in cementitious compositions and/or as dispersant for agrochemical formulations, preferably in cleaning compositions and/or in fabric and home care products, in particular cleaning compositions for improved clay removal or oily and fatty stain removal, wherein the cleaning composition is preferably a laundry detergent formulation and/or a manual dish wash detergent formulation, more preferably a liquid laundry detergent formulation and/or a liquid manual dish wash detergent formulation.

The alkoxylated nitrogen containing polymer can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one alkoxylated nitrogen containing polymer, as defined above.

Preferably, it is a cleaning composition and/or fabric and home care product, comprising at least one alkoxylated nitrogen containing polymer, as defined above, preferably for improved clay removal or oily and fatty stain removal, preferably a laundry detergent formulation and/or a manual dish wash detergent formulation, more preferably a liquid laundry detergent formulation and/or a liquid manual dish wash detergent formulation.

In another preferred embodiment of the present invention, the cleaning composition may be used for soil removal of particulate stains and/or oily and fatty stains, and additionally for whiteness maintenance, preferably in laundry care.

In another embodiment, the cleaning composition of the present invention is a hard surface cleaning composition that may be used for cleaning various surfaces such as hard wood, tile, ceramic, plastic, leather, metal, glass.

In another embodiment, the cleaning composition of the present invention is a liquid or solid automatic dish wash detergent composition, preferably a solid automatic dish wash detergent composition, that may be used for cleaning dish ware, e.g., dish ware such as glasses, wherein the inventive alkoxylated nitrogen containing polymer is improving the removal of stubborn soils. In another embodiment, the cleaning composition is designed to be used in personal care and pet care compositions such as shampoo compositions, body wash formulations, liquid or solid soaps.

In this invention, a preferred area of application for the use of the alkoxylated nitrogen containing polymer is the field of fabric and home care products and cleaning compositions, preferably cleaning compositions for industrial and institutional use and the use by consumers in their household.

### Embodiment 17

The use according to Embodiment 16 in cleaning compositions and/or in fabric and home care products, preferably in liquid and solid detergent compositions, such detergent compositions preferably being
a) manual and automatic dish wash detergent compositions, comprising the at least one alkoxylated nitrogen containing polymer, and the at least one chelating agent and/or the at least one surfactant or—more preferably—a chelating agent in case of a liquid or solid automatic dish wash composition and a surfactant system in case of a liquid manual dish wash detergent composition, respectively; and/or
b) laundry detergent compositions comprising the at least one alkoxylated nitrogen containing polymer, and at least one surfactant or—preferably—a surfactant system.

Within such preferred application areas of use, typical tasks have to be fulfilled, all of which are commonly encompassed by the term “cleaning”, but in fact comprise different tasks such as clay removal or removing oily and fatty residues, solid residues, amphiphilic residues and hydrophilic residues. Other tasks are the protection of the goods to be cleaned from deterioration, such as protecting glass from corroding, silverware from oxidation, colors from fading etc. Other tasks are improving the overall appearance of the to be cleaned goods, such as increasing or restoring the color, the whiteness, imparting or increasing a shine. For many such applications additional ingredients are typically added, for cleaning applications important ones are for example enzymes, which help biologically to degrade residues.

### Embodiment 18

The use according to any of Embodiments 16 to 17 for
i) clay removal, and/or
ii) improved removal of oily/fatty stains, and/or
iii) soil removal of particulate stains, and/or
iv) dispersion and/or emulsification of soils, and/or
v) modification of treated surface to improve removal upon later re-soiling, and/or
vi) whiteness improvement, and/or
vii) —when at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases, is present—additionally for improvement of removal of oily/fatty stains, food stain removal and/or removal of complex stains,
most preferably in cleaning compositions for
   i) clay removal and/or ii) removal of oily/fatty stains,
   each of the before mentioned options i) to vii) preferably for use in a laundry detergent formulation and/or a manual dish wash detergent formulation and/or in a formulation suitable for (pre)-treatment of textiles and/or soap bars, more preferably in a liquid laundry detergent formulation and/or a liquid manual dish wash detergent formulation.

### Embodiment 19

The use according to any of Embodiments 16 to 18 in cleaning compositions and/or in fabric and home care products, preferably in cleaning compositions for in fabric and home care, the cleaning composition preferably being a laundry detergent formulation or a dish wash detergent formulation, even more preferably being a liquid laundry detergent formulation or a liquid dish wash detergent formulation.

Such ingredients are typically formulated with other ingredients in formulations and compositions, which may be also called “products” (as they are provided from a supplier as a formulation to another customer who uses such formulation directly for cleaning purposes etc. or for producing another formulation, which in turn could be sold to consumers as a “product” to be used by the consumer).

### Embodiment 20

A composition that is a fabric and home care product, cleaning composition, industrial and institutional cleaning product, cosmetic or personal care product, oil field-formulation such as crude oil emulsion breaker, pigment dispersion for inks such as ink-jet inks, electro plating product, cementitious composition, lacquer, paint, agrochemical formulation, preferably a laundry detergent, a dish wash composition, a cleaning composition and/or a fabric and home care product, each comprising at least one alkoxylated nitrogen containing polymer according to any of the Embodiments 1 to 12 or obtained by or obtainable by a process according to any of Embodiments 13-14.

### Embodiment 21

A composition according to Embodiment 20 being a solid or liquid laundry detergent composition or a solid or liquid manual dish wash detergent composition, preferably a liquid laundry detergent or liquid manual dish wash detergent composition, more preferably a liquid laundry detergent composition, comprising the least one alkoxylated nitrogen containing polymer, preferably the at least one alkoxylated nitrogen containing polymer according to any one of Embodiments 1 to 12 or obtained by or obtainable by a process according to any of Embodiments 13-14;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases, optionally containing at least one antimicrobial agent,
wherein the at least one alkoxylated nitrogen containing polymer is present in an amount ranging from about 0.01% to about 20%, preferably from about 0.05% to 15%, more preferably from about 0.1% to about 10%, and most preferably from about 0.5% to about 5%, in relation to the total weight of such composition or product, and
such product or composition further comprising from about 1% to about 70% by weight of at least one surfactant, preferably an anionic surfactant, or even more preferably of a surfactant system comprising at least one anionic surfactant.

### Embodiment 22

A composition being a solid or liquid automatic dish wash detergent composition, preferably a solid automatic dish wash detergent composition, comprising the at least one second intermediate (12) according to Embodiment 15 (the compound that is the second intermediate (I2) according to Embodiment 1, step b)),
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases and amylases,
optionally containing at least one antimicrobial agent,
optionally containing at least one compound selected from alkali metal percarbonate, alkali metal perborate and alkali metal persulfate,
optionally containing at least one zinc salt,
optionally at least one chelating agent selected from methylglycinediaceticacid (MGDA), glutamic acid diacetate (GLDA), citric acid and salts thereof,
wherein the at least one second intermediate (I2) is being present in a total amount ranging from about 0.001% to about 10%, preferably from about 0.005% to 5%, more preferably from about 0.01% to about 3%, and most preferably from about 0.1% to about 2%, and such product or composition further comprising at least one chelating agent being present in a total amount from about 1% to about 70%, preferably from 10% to about 60% and even more preferably from 30% to about 50%, and
optionally further comprising at least one surfactant or more preferably a surfactant system in a total amount of from about 1% to about 70% by weight,
all weight percent in relation to the total weight of such composition.

### Embodiment 23

A composition according to Embodiment 22, being a solid automatic dish wash detergent composition, comprising the at least one second intermediate (I2) according to Embodiment 15 (the compound that is the second intermediate (I2) according to Embodiment 1, step b)), additionally comprising at least one chelating agent selected from methylglycinediaceticacid (MGDA), glutamic acid diacetate (GLDA), citric acid and salts thereof,
at least one enzyme selected from proteases and/or amylases,
at least one bleaching agent selected from alkali metal percarbonate, alkali metal perborate and alkali metal persulfate, preferably alkali metal percarbonate,
at least one non-ionic surfactant,
optionally at least one disintegrant, preferably a super-disintergrant, more preferably PVPP, and optionally containing at least one zinc salt.

Super-disintegrants are known by a person of skill in the art, e.g. from EP1004661, EP1263814 and EP1036839, and are discussed also in Pharmaceutical Technology, Volume 2006 Supplement, Issue 5, “A Comparative Study of Current Superdisintegrants”, Oct. 1, 2006.

### Embodiment 24

Composition according to Embodiment 22 and 23 being a detergent composition, wherein the second intermediate (I2) according to Embodiment 15 (the compound that is the second intermediate (I2) according to Embodiment 1, step b)), is employed for preventing or reducing glass corrosion.

### Embodiment 25

Composition according to any of Embodiments 20 and 21 being a detergent composition, comprising as surfactant at least one anionic surfactant.

### Embodiment 26

Composition according to any of Embodiments 20, 21 and 25 being a liquid detergent composition, comprising as surfactant at least one non-ionic surfactant, and further comprising water.

### Embodiment 27

Composition according to any of Embodiments 20, 21, 25 and 26, being a liquid detergent composition, comprising as surfactant at least one non-ionic surfactant, further comprising water and additionally comprising at least one enzyme selected from the list consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types, preferably selected from one or more lipases, hydrolases, amylases, proteases, cellulases, and combinations of at least two of the foregoing types, more preferably at least one enzyme being selected from proteases.

### Embodiment 28

Composition according to any of Embodiments 20, 21 and 25 to 27 being a detergent composition, comprising at least one further polymer selected from multifunctional alkoxylated polyethylene imines, multifunctional alkoxylated diamines, or terephthalic acid-based soil release polyesters, or mixtures thereof.

### Embodiment 29

Composition according to any of Embodiments 20, 21 and 25 to 28 being a liquid detergent composition, comprising as surfactant at least one 2-propylheptyl ethoxylated non-ionic surfactant having an average degree of ethoxylation of from 3 to 8.

### Embodiment 30

Composition according to any one of Embodiments 20 to 29 further comprising an antimicrobial agent selected from the group consisting of 2-phenoxyethanol and 4,4′-dichoro 2-hydroxydiphenylether; preferably comprising 2-phenoxyethanol in an amount ranging from 2 ppm to 5% by weight of the composition; more preferably comprising 0.1 to 2% of phenoxyethanol or preferably comprising 4,4′-dichoro 2-hydroxydiphenylether in a concentration from 0.001 to 3%, more preferably 0.002 to 1%, even more preferably 0.01 to 0.6%, each by weight of the composition.

### Embodiment 31

Method of preserving an aqueous composition according to any one of Embodiments 20 to 30 against microbial contamination or growth, which method comprises addition of an antimicrobial agent selected from the group consisting of 2-phenoxyethanol and 4,4′-dichoro 2-hydroxydiphenylether.

It is also preferred in the present invention that the cleaning composition comprises (besides at least one alkoxylated nitrogen containing polymer as described above) additionally at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, preferably selected from one or more lipases, hydrolases, amylases, proteases, cellulases and combinations of at least two of the foregoing types, more preferably at least one enzyme being selected from proteases.

Preferably, the such inventive cleaning composition is a fabric and home care product or an industrial and institutional (I&I) cleaning product, preferably a fabric and home care product, more preferably a laundry detergent or manual dish washing detergent, comprising at least one inventive alkoxylated nitrogen containing polymer, and optionally further comprising at least one surfactant or a surfactant system, providing improved removal, dispersion and/or emulsification of soils and/or modification of treated surfaces and/or whiteness maintenance of treated surfaces.

At least one inventive alkoxylated nitrogen containing polymer as described herein (such alkoxylated nitrogen containing polymer as defined before and especially in the Embodiments 1 to 12 are in this following section also termed “inventive polymer”) is present in said inventive cleaning compositions at a concentration of from about 0.01% to about 20%, preferably from about 0.05% to 15%, more preferably from about 0.1% to about 10%, and most preferably from about 0.5% to about 5%, in relation to the total weight of such composition or product; such cleaning composition may—and preferably does—further comprise a from about 1% to about 70% by weight of a surfactant system.

Even more preferably, the cleaning compositions of the present invention comprising at least one inventive polymer, and optionally further comprising at least one surfactant or a surfactant system, are those for primary cleaning (i.e., removal of stains) within laundry and manual dish wash applications, even more specifically, for removal of clay or oily and fatty stains such as those on fabrics and dishware, and may additionally comprise at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types of enzymes, more preferably at least one enzyme being selected from proteases.

In one preferred embodiment, the cleaning composition of the present invention is a liquid or solid laundry detergent composition.

In another preferred embodiment, the cleaning composition of the present invention is a liquid or solid (e.g., powder or tab/unit dose) detergent composition for manual or automatic dish wash, preferably either a liquid manual dish wash detergent composition or a solid automatic dish wash composition.

In one embodiment, the inventive polymers of the present invention may be utilized in cleaning compositions comprising a surfactant system comprising C10-C15 alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive polymers may be utilized in cleaning compositions, such as laundry detergents of any kind, and the like, comprising C8-C18 linear or branched alkyl ether sulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive polymers may be utilized in cleaning compositions, such as laundry detergents of any kind, and the like, comprising C12-C18 alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In a further embodiment the inventive polymers may be utilized in cleaning compositions, such as laundry detergents of any kind, and the like, comprising bio-based surfactants like rhamnolipids and/or sophorolipids as the primary surfactant.

In one embodiment of the present invention, the inventive polymer is a component of a cleaning composition, such as preferably a laundry or a dish wash formulation, more preferably a liquid laundry or manual dish wash formulation, that each additionally comprise at least one surfactant, preferably at least one anionic surfactant.

The selection of the additional surfactants in these embodiments may be dependent upon the application and the desired benefit.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e., contain other ingredients), “consist essentially of” (comprise mainly or almost only the mentioned ingredients and other ingredients in only very minor amounts, mainly only as impurities), or “consist of” (i.e., contain only the mentioned ingredients and in addition may contain only impurities not avoidable in a technical environment, preferably only the ingredients) the components of the present disclosure.

The term “at least one”, as used herein, includes but is not limited to 1, 2, 3, 4, 5, 6, 7, 8, 9 and more.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about”, as used herein, encompasses the exact number “X” mentioned as e.g., “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under atmospheric pressure. In all embodiments of the present disclosure, all percentages are by weight of the total composition, unless specifically stated otherwise. All ratios are weight ratios, unless specifically stated otherwise.

Description of Cleaning Compositions, Formulations and their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces. “Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive polymers and compositions comprising such polymers.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose: a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20° C.; liquid laundry cleaning compositions have a viscosity of preferably from 50 to 3000 mPa*s, more preferably from 100 to 1500 mPa*s and most preferably from 200 to 1000 mPa*s at 20 1/s and 20° C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25° C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive polymer, preferably at least one polymer in amounts suitable for expressing a certain property within such a composition, especially when such a composition is used in its area of use.

One aspect of the present invention is also the use of the inventive polymers as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, dye fixation agent and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 1 and 6,326,348 E1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### (a) Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactant classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C9-C20 linear alkylbenzenesulfonates (LAS), C10-C20 primary, branched chain and random alkyl sulfates (AS); C10-C18 secondary (2,3) alkyl sulfates; C10-C18 alkyl alkoxy sulfates (AExS) wherein x is from 1 to 30; C10-C18 alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C8-C12-alkyl sulfates, of C12-C18-fatty alcohol ether sulfates, of C12-C18-fatty alcohol polyether sulfates, of sulfuric acid half-esters of ethoxylated C4-C12-alkylphenols (ethoxylation: 3 to 50 mol of ethylene oxide/mol), of C12-C18-alkylsulfonic acids, of C12-C18 sulfo fatty acid alkyl esters, for example of C12-C18 sulfo fatty acid methyl esters, of C10-C18-alkylarylsulfonic acids, preferably of n-C10-C18-alkylbenzene sulfonic acids, of C10-C18 alkyl alkoxy carboxylates and of soaps such as for example C8-C24-carboxylic acids. Preference is given to the alkali metal salts of the aforementioned compounds, particularly preferably the sodium salts.

In one embodiment of the present invention, anionic surfactants are selected from n-C10-C18-alkylbenzene sulfonic acids and from fatty alcohol polyether sulfates, which, within the context of the present invention, are in particular sulfuric acid half-esters of ethoxylated C12-C18-alkanols (ethoxylation: 1 to 50 mol of ethylene oxide/mol), preferably of n-C12-C18-alkanols.

In one embodiment of the present invention, also alcohol polyether sulfates derived from branched (i.e., synthetic) C11-C18-alkanols (ethoxylation: 1 to 50 mol of ethylene oxide/mol) may be employed.

Preferably, the alkoxylation group of both types of alkoxylated alkyl sulfates, based on C12-C18-fatty alcohols or based on branched (i.e., synthetic) C11-C18-alcohols, is an ethoxylation group and an average ethoxylation degree of any of the alkoxylated alkyl sulfates is 1 to 5, preferably 1 to 3.

In a further embodiment of the present invention, anionic surfactants are selected from rhamnolipids and/or sophorolipids.

Preferably, the laundry detergent formulation of the present invention comprises from at least 1 wt.-% to 50 wt.-%, preferably in the range from greater than or equal to about 2 wt.-% to equal to or less than about 30 wt.-%, more preferably in the range from greater than or equal to 3 wt.-% to less than or equal to 25 wt.-%, and most preferably in the range from greater than or equal to 5 wt.-% to less than or equal to 25 wt.-% of one or more anionic surfactants as described above, based on the particular overall composition, including other components and water and/or solvents.

In a preferred embodiment of the present invention, anionic surfactants are selected from C10-C15 linear alkylbenzenesulfonates, C10-C18 alkylethersulfates with 1-5 ethoxy units and C10-C18 alkylsulfates.

Non-limiting examples of non-ionic surfactants—which may be employed also in combinations of more than one other surfactant—include: C8-C18 alkyl ethoxylates, such as, NEODOL® non-ionic surfactants from Shell; ethylenoxide/propylenoxide block alkoxylates as PLURONIC® from BASF; C14-C22 mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides).

Preferred examples of alkoxylated alcohols and alkoxylated fatty alcohols are, for example, compounds of the general formula (A)

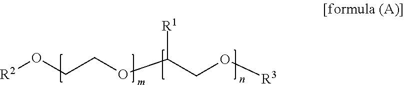

in which the variables are defined as follows:
R1 is selected from linear C1-C10-alkyl, preferably ethyl and particularly preferably methyl,
R2 is selected from C8-C22-alkyl, for example n-C8H17, n-C10H21, n-C12H25, n-C14H29, n-C16H33 or n-C18H37,
R3 is selected from C1-C10-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one. Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

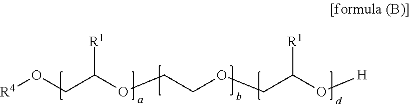

in which the variables are defined as follows:
R1 is identical or different and selected from linear C1-C4-alkyl, preferably identical in each case and ethyl and particularly preferably methyl,
R4 is selected from C6-C20-alkyl, in particular n-C8H17, n-C10H21, n-C12H25, n-C14H29, n-C16H33, n-C18H37,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EP-A 0 851 023 and in DE-A 198 19 187. Mixtures of two or more different non-ionic surfactants may of course also be present.

In a preferred embodiment of the present invention, non-ionic surfactants are selected from C12/14 and C16/18 fatty alkoholalkoxylates, C13/15 oxoalkoholalkoxylates, C13-alkoholalkoxylates, and 2-propylheptylalkoholalkoxylates, each of them with 3-15 ethoxy units, preferably 4-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R1=C8-18 alkyl moiety and two R2 and R3 moieties selected from the group consisting of C1-C3 alkyl groups and C1-C3 hydroxyalkyl groups. Preferably, the amine oxide is characterized by the formula

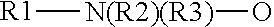

wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt.-%, more preferably at least 75 wt.-% to 100 wt.-% of the mid-branched amine oxides for use herein. The amine oxide further comprises two moieties, independently selected from a C1-C3 alkyl, a C1-C3 hydroxyalkyl group, or a polyethylene oxide group containing an average of from about 1 to about 3 ethylene oxide groups. Preferably the two moieties are selected from a C1-C3 alkyl, more preferably both are selected as a C1 alkyl.

In a preferred embodiment of the present invention, amphoteric surfactants are selected from C8-C18 alkyl-dimethyl aminoxides and C8-C18 alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C12-C18-alkylbetaines and sulfobetaines. The zwitterionic surfactant preferably is a betaine surfactant, more preferably a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphatefree”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na2CO3.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepentamethylenephosphonate (DTPMP), and also their higher homologues. They are preferably used in the form of the neutrally reacting sodium salts, e.g., as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na2Si2O5, β-Na2Si2O5, and δ-Na2Si2O5.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C2-C16-alkyl disuccinates, C2-C16-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid. It is also possible to use copolymers of at least one monomer from the group consisting of monoethylenically unsaturated C3-C10-mono- or C4-C10-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C22-α-olefin, a mixture of C20-C24-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the laundry formulation according to the invention comprises additionally at least one enzyme.

In one embodiment, the composition according to the present invention additionally comprises at least one enzyme.

Preferably, the at least one enzyme is a detergent enzyme.

In one embodiment, the enzyme is classified as an oxidoreductase (EC 1), a transferase (EC 2), a hydrolase (EC 3), a lyase (EC 4), an isomerase (EC 5), or a ligase (EC 6). The EC-numbering is according to Enzyme Nomenclature, Recommendations (1992) of the Nomenclature Committee of the International Union of Biochemistry and Molecular Biology including its supplements published 1993-1999. Preferably, the enzyme is a hydrolase (EC 3).

In a preferred embodiment, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the enzyme is a protease, preferably, a serine protease, more preferably, a subtilisin protease.

Preferably, the protease is a protease with at least 90% sequence identity to SEQ ID NO: 22 of EP1921147B1 and having the amino acid substitution R101E (according to BPN′ numbering). Preferably, the amylase is an amylase with at least 90% sequence identity to SEQ ID NO: 54 of WO2021032881A1.

The composition of the present invention can comprise one type of enzyme or more than one enzyme of different types, e.g., an amylase and a protease, or more than one enzyme of the same type, e.g., two or more different proteases, or mixtures thereof, e.g., an amylase and two different proteases.

The enzyme(s) can be incorporated into the composition at levels sufficient to provide an effective amount for achieving a beneficial effect, preferably for primary washing effects and/or secondary washing effects, like anti-greying or antipilling effects (e.g., in case of cellulases). Preferably, the enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition.

Preferably, the enzyme-containing composition further comprises an enzyme stabilizing system. Preferably, the enzyme-containing composition described herein comprises from about 0.001% to about 10%, from about 0.005% to about 8%, or from about 0.01% to about 6%, by weight of the composition, of an enzyme stabilizing system. The enzyme stabilizing system can be any stabilizing system which is compatible with the enzyme.

Preferably, the enzyme stabilizing system comprises at least one compound selected from the group consisting of polyols (preferably, 1,3-propanediol, ethylene glycol, glycerol, 1,2-propanediol, or sorbitol), inorganic salts (preferably, CaCl2, MgCl2, or NaCl), short chain (preferably, C1-C3) carboxylic acids or salts thereof (preferably, formic acid, formate (preferably, sodium formate), acetic acid, acetate, or lactate), borate, boric acid, boronic acids (preferably, 4-formyl phenylboronic acid (4-FPBA)), peptide aldehydes (preferably, Z-VAL-H or Z-GAY-H), peptide acetals, and peptide aldehyde hydrosulfite adducts. Preferably, the enzyme stabilizing system comprises a combination of at least two of the compounds selected from the group consisting of salts, polyols, and short chain carboxylic acids and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if proteases are present in the composition, protease inhibitors may be added, preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts.

Compositions according to the invention may comprise one or more bleaching agent (bleaches).

Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, (S)NOBS, LOBS, DOBA, PAP, N-methylmorpholiniumacetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

As precursors of H₂O₂ peroxides come into consideration. i. e. every compound which is capable of yielding hydrogen peroxide in aqueous solutions, for example, the organic and inorganic peroxides known in the literature and available commercially that bleach textile materials at conventional washing temperatures, for example at from 10 to 95° C.

Preferably, however, inorganic peroxides are used, for example persulfates, perborates, percarbonates and/or persilicates. They are typically used in an amount of 2-80 wt-%, preferably of 4-30 wt-%, based on the weight of the composition.

Typically, the compound of formula (1)

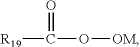

as described in more detail below, is present in the composition in an amount of 0.05-15 wt-%, preferably from 0.1 to 10 wt-%, based on the weight of the total composition.

Examples of suitable inorganic peroxides are sodium perborate tetrahydrate or sodium perborate monohydrate, sodium percarbonate, inorganic peroxyacid compounds, such as for example potassium monopersulphate (MPS). If organic or inorganic peroxyacids are used as the peroxygen compound, the amount thereof will normally be within the range of about 2-80 wt-%, preferably from 4-30 wt-%, based on the weight of the composition.

The organic peroxides are, for example, mono- or poly-peroxides, urea peroxides, a combination of a C₁-C₄alkanol oxidase and C₁-C₄alkanol (Such as methanol oxidase and ethanol as described in WO95/07972), alkylhydroxy peroxides, such as cumene hydroperoxide and t-butyl hydroperoxide.

The peroxides may be in a variety of crystalline forms and have different water contents, and they may also be used together with other inorganic or organic compounds in order to improve their storage stability.

As oxidants, peroxo acids can also be used. One example are organic mono peracids of formula (1)

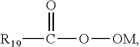

wherein
M signifies hydrogen or a cation,
R₁₉ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted.

Preferred mono organic peroxy acids and their salts are those of formula

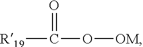

wherein
M signifies hydrogen or an alkali metal, and
R′₁₉ signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also ε-phthalimido peroxy hexanoic acid and its alkali salts (PAP). Also suitable are diperoxyacids, for example, 1,12-diperoxydodecanedioic acid (DPDA), 1,9-diperoxyazelaic acid, diperoxybrassilic acid, diperoxysebasic acid, diperoxyisophthalic acid, 2-decyldiperoxybutane-1,4-diotic acid and 4,4′-sulphonylbisperoxybenzoic acid.

In some cases, the use of an additional bleach activator may be of advantage.

The term bleach activator is frequently used as a synonym for peroxyacid bleach precursor. All the above mentioned peroxy compounds may be utilized alone or in conjunction with a peroxyacid bleach precursor.

Such precursors are the corresponding carboxyacid or the corresponding carboxyanhydride or the corresponding carbonylchlorid, or amides, or esters, which can form the peroxy acids on perhydrolysis. Such reactions are commonly known.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N,N-diacetyl-N,N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (10):

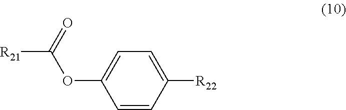

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; acylated polyhydric alcohols, especially triacetin, ethylene glycol diacetate and 2,5-diacetoxy-2,5-dihydrofuran; and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N,N,N-trimethyl ammonium) ethyl sodium-4-sulphonphenyl carbonate chloride—(SPCC), N-octyl,N,N-dimehyl-N10-carbophenoxy decyl ammonium chloride—(ODC), 3-(N,N,N-trimethyl ammonium) propyl sodium-4-sulphophenyl carboxylate and N,N,N-trimethyl ammonium toluyloxy benzene sulphonate.

It is also possible to use additional bleach catalysts, which are commonly known, for example transition metal complexes as disclosed in EP 1194514, EP 1383857 or WO04/007657. Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional alkoxylated polyethylene imines” (for example BASF's Sokalan® HP20), “multifunctional alkoxylated diamines” (for example BASF's Sokalan® HP96), BASF's Sokalan® SR400 A and also terephthalic acid-based polyesters like Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional ethoxylated polyethylene imines have 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional alkoxylated diamines are typically ethoxylated C2 to C12 alkylene diamines, preferably hexamethylene diamine, which are further quaternized and optionally sulfated. Typical multifunctional alkoxylated diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

In a preferred embodiment of the present invention, the cleaning compositions may contain at least one multifunctional alkoxylated polyethylene imine and/or at least one multifunctional alkoylated diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt.-%, preferably from 0.1 to 10 wt.-% and more preferably from 0.25 to 5 wt.-% and even as low as up to 2 wt. %, based on the particular overall composition, including other components and water and/or solvents. In another preferred embodiment of the present invention, the cleaning compositions may contain at least one terephthalic acid-based polyester, employed as soil release polymer, to improve the whiteness of the fabrics after the wash, especially the whiteness of polyester fabrics. Thus, one aspect of the present invention is a laundry detergent composition, in particular a liquid laundry detergent, comprising (i) at least one inventive polymer and (ii) at least one compound selected from multifunctional alkoxylated polyethylene imines, multifunctional alkoxylated diamines and terephthalic acid-based polyesters, and mixtures thereof.

In one embodiment of the present invention, the ratio of the at least one inventive polymer and (ii) the at least one compound selected from multifunctional alkoxylated polyethylene imines, multifunctional alkoxylated diamines and terephthalic acid-based polyesters, and mixtures thereof, is from 10:1 to 1:10, preferably from 5:1 to 1:5 and more preferably from 3:1 to 1:3. Laundry formulations comprising the inventive polymer may also comprise at least one antimicrobial agent (also often named preservatives).

The composition may contain one or more antimicrobial agents and/or preservatives as listed in patent WO2021/115912 A1 on pages 35 to 39.

Especially of interest are the following antimicrobial agents and/or preservatives: 4,4′-dichloro 2-hydroxydiphenyl ether (CAS-No. 3380-30-1), further names: 5-chloro-2-(4-chlorophenoxy) phenol, Diclosan, DCPP, which is commercially avail-able as a solution of 30 wt % of 4,4′-dichloro 2-hydroxydiphenyl ether in 1,2 propyl-eneglycol under the trade name Tinosan® HP 100 (BASF); 2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE); 2-bromo-2-nitropropane-1,3-diol (CAS-No. 52-51-7, further names: 2-bromo-2-nitro-1,3-propanediol, Bronopol®, Protectol® BN, Myacide AS); Glutaraldehyde (CAS-No. 111-30-8, further names: 1-5-pentandial, pentane-1,5-dial, glutaral, glutardialdehyde, Protectol® GA, Protectol® GA 50, Myacide® GA); Glyoxal (CAS No. 107-22-2; further names: ethandial, oxylaldehyde, 1,2-ethandial, Protectol® GL); 2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3(2H)-one (BIT, CAS No. 2634-33-5); Hexa-2,4-dienoic acid (Sorbic acid, CAS No. 110-44-1) and its salts, e.g. calcium sorbate, sodium sorbate, potassium (E,E)-hexa-2,4-dienoate (Potassium Sorbate, CAS No. 24634-61-5); Lactic acid and its salts; L-(+)-lactic acid (CAS No. 79-33-4); Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate; Salicylic acid and its salts, e.g. calcium salicylate, magnesium salicylate, MEA salicylate, sodium salicylate, potassium salicylate, TEA salicylate; Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9); Didecyldimethylammonium chloride (DDAC, CAS No. 68424-95-3 and CAS No. 7173-51-5); N-(3-aminopropyl)-N-dodecylpropane-1,3-diamine (Diamine, CAS No. 2372-82-9); Peracetic acid (CAS No. 79-21-0); Hydrogen peroxide (CAS No. 7722-84-1).

The antimicrobial agent is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further encompasses a method of preserving an aqueous composition according to the invention against microbial contamination or growth, which method comprises addition of 2-Phenoxyethanol. The invention thus further encompasses a method of providing an antimicrobial effect on textiles after treatment with a solid laundry detergent e.g., powders, granulates, capsules, tablets, bars etc.), a liquid laundry detergent, a softener or an after rinse containing 4,4′-dichloro 2-hydroxydiphenyl ether (DCPP).

In a further embodiment, this invention also encompasses a composition comprising an inventive polymer as descried herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an inventive polymer as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an inventive polymer as described herein before, such composition further comprising 4,4′-dichoro 2-hydroxydiphenylether.

The term “dye fixation agent”, as used herein, relates to compounds that attenuate or even terminate dye bleeding of colored fabrics during the washing process. Dye fixation agents include, but are not limited to cationic dye fixation agents, crosslinking fixation agents and formaldehyde-based fixation agents. The skilled person is well-aware of these compounds and may purchase commercially available products from BASF SE, Huntsman, Archroma, Fineotex, Biotex Malaysia or Dystar. Exemplified, but not limiting dye fixation agents are Basilen Fixing Agent F-RP, Albafix ECO, Finofix NF, poly DADMAC, Polyamine (DCDA-DETA, Epichloro-DMA, Epichloro-DETA, etc.).

Formulations according to the invention may also comprise water and/or additional organic solvents, e.g., ethanol or propylene glycol.

Further optional ingredients may be but are not limited to viscosity modifiers, foam boosting or foam reducing agents, perfumes, dyes, optical brighteners, and dye transfer inhibiting agents.

### (b) General Cleaning Compositions and Formulations

The liquid formulations disclosed in this chapter may comprise 0 to 2% 2-phenoxyethanol, preferably about 1%, in addition to all other mentioned ingredients.

The above and below disclosed liquid formulations may comprise 0-0.2% 4,4′-dichoro 2-hydroxydiphenylether, preferably about 0.15%, in addition to all other mentioned ingredients.

The bleach-free solid laundry compositions may comprise 0-0.2% 4,4′-dichoro 2-hydroxydiphenylether, preferably about 0.15%, in addition to all other mentioned ingredients. The formulations disclosed in this chapter may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive polymer may be added to such formulation(s) in suitable amounts as outlined herein.

When the shown composition does not comprise an inventive polymer, such composition is a comparative composition. When it comprises an inventive polymer, especially in the amounts that are described herein as preferred, more preferred etc. ranges, such compositions are considered to fall within the scope of the present invention.

In a preferred embodiment the at least one alkoxylated nitrogen containing polymer (as defined in any of the embodiments herein, especially the Embodiments 1 to 12; alkoxylated nitrogen containing polymers in this section also named “inventive polymer”) is used in a laundry detergent.

Liquid laundry detergents according to the present invention are composed of:
0.05-20% of at least one inventive polymer
1-50% of surfactants
0.1-40% of builders, cobuilders and/or chelating agents
0.1-50% other adjuncts
water to add up 100%.

Preferred liquid laundry detergents according to the present invention are composed of:
0.2-6% of at least one inventive polymer
5-40% of anionic surfactants selected from C10-C15-LAS and C10-C18 alkyl ether sulfates containing 1-5 ethoxy-units
1.5-10% of nonionic surfactants selected from C10-C18-alkyl ethoxylates containing 3 10 ethoxy-units
2-20% of soluble organic builders/cobuilders selected from C10-C18 fatty acids, di- and tricarboxylic acids, hydroxy-di- and hydroxytricaboxylic acids and polycarboxylic acids
0.05-5% of an enzyme system containing at least one enzyme suitable for detergent use and preferably also an enzyme stabilizing system
0.5-20% of mono- or diols selected from ethanol, isopropanol, ethylene glycol, or propylene glyclol
0.1-20% other adjuncts
water to add up to 100%.

Solid laundry detergents (like e.g., powders, granules or tablets) according to the present invention are composed of:
0.05-20% of at least one inventive polymer
1-50% of surfactants
0.1-80% of builders, cobuilders and/or chelating agents
0-50% fillers
0-40% bleach actives
0.1-30% other adjuncts and/or water
wherein the sum of the ingredients adds up 100%.

Preferred solid laundry detergents according to the present invention are composed of:
0.2-6% of at least one inventive polymer
5-30% of anionic surfactants selected from C10-C15-LAS, C10-C18 alkyl sulfates and C10-C18 alkyl ether sulfates containing 1-5 ethoxy-units
1.5-7.5% of non-ionic surfactants selected from C10-C18-alkyl ethoxylates containing 3-10 ethoxy-units
5-50% of inorganic builders selected from sodium carbonate, sodium bicarbonate, zeolites, soluble silicates, sodium sulfate
0.5-15% of cobuilders selected from C10-C18 fatty acids, di- and tricarboxylic acids, hydroxydi- and hydroxytricarboxylic acids and polycarboxylic acids
0.1-5% of an enzyme system containing at least one enzyme suitable for detergent use and preferably also an enzyme stabilizing system
0.1-20% other adjuncts
water to add up to 100%

In a preferred embodiment the polymer according to the present invention is used in a manual dish wash detergent.

Liquid manual dish wash detergents according to the present invention are composed of:
0.05-10% of at least one inventive polymer
1-50% of surfactants
0.1-50% of other adjuncts
water to add up 100%.

Preferred liquid manual dish wash detergents according to the present invention are composed of:
0.2-5% of at least one inventive polymer
5-40% of anionic surfactants selected from C10-C15-LAS, C10-C18 alkyl ether sulfates containing 1-5 ethoxy-units, and C10-C18 alkyl sulfates
0-10% of Cocamidopropylbetaine
0-10% of Lauramine oxide
0-2% of a non-ionic surfactant, preferably a C10-Guerbet alcohol alkoxylate
0-5% of an enzyme, preferably Amylase, and preferably also an enzyme stabilizing system
0.5-20% of mono- or diols selected from ethanol, isopropanol, ethylenglycol, or propylenglyclol
0.1-20% other adjuncts
water to add up to 100%

As the alkoxy-shell of the alkoxylated nitrogen containing polymers of the invention may be biodegradable, and especially the cleaning formulations typically have a pH of about 7 or higher, and additionally often contain also enzymes—which are included into such cleaning formulations to degrade biodegradable stuff such as grease, proteins, polysaccharides etc. which are present in the stains and dirt which shall be removed by the cleaning compositions—some consideration may be needed to be taken to formulate those potentially “shell bio-degradable” polymers of the invention. Such formulations suitable are in principle known, and include the formulation in solids—where the enzymes and the polymers can be separated by coatings or adding them in separate particles which are mixed—and liquids and semi-liquids, where the polymers and the enzymes can be separated by formulating them in different compartments, such as different compartments of multi-chamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world. The at least one inventive polymer may be added to such formulation(s) in suitable amounts as outlined herein.

TABLE 1
General formula for laundry detergent compositions
according to the invention:

| | Ranges of Ingredient in Liquid frame |
|---|---|
| Ingredient | formulations |
| Linear alkyl benzene sulphonic | 0 to 30% |
| acid | |
| Coco fatty acid | 1 to 12% |
| Fatty alcohol ether sulphate | 0 to 25% |
| NaOH or mono- or triethanolamine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| water | Up to 100% |

TABLE 2
Liquid laundry frame formulations according to the invention:

| active | | | | | | | | |
|---|---|---|---|---|---|---|---|---|
| (numbers: % active) | F1 | F2 | F3 | F4 | F5 | | F6 | |
| alcohol ethoxylate 7EO | 5.40 | 10.80 | 12.40 | 7.30 | 1.60 | | 7.60 | |
| Coco fatty acid K12-18 | 2.40 | 3.10 | 3.20 | 3.20 | 3.50 | | 6.40 | |
| Fatty alcohol ether sulphate | 5.40 | 8.80 | 7.10 | 7.10 | 5.40 | | 14.00 | |
| Linear alkyl benzene | 5.50 | 0.00 | 14.50 | 15.50 | 10.70 | | 0.00 | |
| sulphonic acid | | | | | | | | |
| 1,2 Propane diol | 6.00 | 3.50 | 8.70 | 8.70 | 1.10 | | 7.80 | |
| Triethanolamine | | | | | | | | |
| Monoethanolamine | | | 4.00 | 4.30 | 0.30 | | | |
| NaOH | 2.20 | 1.10 | | | | | 1.00 | |
| Glycerol | | 0.80 | 3.00 | 2.80 | | | | |
| Ethanol | 2.00 | | | | 0.38 | | 0.39 | |
| Na citrate | 3.00 | 2.80 | 3.40 | 2.10 | 7.40 | | 5.40 | |
| Inventive Polymer (s) | 0-5 | 0-5 | 0-5 | 0-5 | 0-5 | | 0-5 | |
| (total) * | | | | | | | | |
| Protease | 0-1 | 0-1 | 0-1 | 0-1 | 0-1 | | 0-1 | |
| Amylase | 0-0.5 | 0-0.5 | 0-0.5 | 0-0.5 | 0-0.5 | | 0-0.5 | |
| Cellulase | 0-0.3 | 0-0.3 | 0-0.3 | 0-0.3 | 0-0.3 | | 0-0.3 | |
| Lipase | 0-0.2 | 0-0.2 | 0-0.2 | 0-0.2 | 0-0.2 | | 0-0.2 | |
| Mannanase | 0-0.2 | 0-0.2 | 0-0.2 | 0-0.2 | 0-0.2 | | 0-0.2 | |
| Pectat Lyase | 0-0.3 | 0-0.3 | 0-0.3 | 0-0.3 | 0-0.3 | | 0-0.3 | |
| water | to 100 | to 100 | to 100 | to 100 | to 100 | | to 100 | |
| active | | | | | | | | |
| (numbers: % active) | F7 | F8 | F9 | F10 | F11 | F12 | F13 | F14 |
| alcohol ethoxylate 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether sulphate | 2.80 | 4.50 | 3.90 | 4.10 | | 10.00 | 22.20 | |
| Linear alkyl benzene sul- | 6.30 | 5.43 | 11.45 | 5.90 | 10.10 | 10.00 | 28.00 | 27.00 |
| phonic acid | | | | | | | | |
| 1,2 Propane diol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive Polymer (s) | 0-5 | 0-5 | 0-5 | 0-5 | 0-5 | 0-5 | 0-5 | 0-5 |
| (total)* | | | | | | | | |
| active | | | | | | | | |
| (numbers: % active) | F7 | F8 | F9 | F10 | F11 | F12 | F13 | F14 |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

*Without inventive polymer the formulations are comparative examples.

TABLE 3
Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene sulphonic | 12.1 | 11.2 | 13.6 | 21.9 | 18.7 | 12.7 |
| acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phosphate | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| | Bleach containing Powder | | | | | |
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene sulphonic | 7.6 | 12.1 | 11.5 | 12.2 | 6.5 | 10.4 |
| acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phosphate | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive Polymer(s) (total) | 2.2 | 9.2 | 2.2 | 0.7 | 1 | 0.4 |

TABLE 4
Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂-C₁₄-alkyl- | 8 | 0 | 6 | 0 | 6 | 0 | 6 | 0 |
| benzenesulfonic acid | | | | | | | | |
| C₁₂-C₁₄-fatty alcohol × 2 | 8 | 16 | 6 | 12 | 6 | 12 | 6 | 12 |
| EO sulfate | | | | | | | | |
| Cocamidopropyl betaine | 0 | 0 | 4 | 4 | 0 | 0 | 2 | 2 |
| Lauramine oxide | 0 | 0 | 0 | 0 | 4 | 4 | 2 | 2 |
| 2-Propylheptanol × 4 EO | 0.5 | 0.5 | 0.5 | 0.5 | 0.5 | 0.5 | 0.5 | 0.5 |
| Inventive | 1 | 1 | 1 | 1 | 1 | 1 | 1 | 1 |
| Polymer (s) (total) | | | | | | | | |
| Ethanol | 2 | 2 | 2 | 2 | 2 | 2 | 2 | 2 |
| 2-Phenoxyethanol (pre- | 1 | 1 | 1 | 1 | 1 | 1 | 1 | 1 |
| servative) | | | | | | | | |
| Sodium chloride | 1 | 1 | 1 | 1 | 1 | 1 | 1 | 1 |
| Demin. water | add | add | add | add | add | add | add | add |
| | 100 | 100 | 100 | 100 | 100 | 100 | 100 | 100 |
| Sodium hydroxide | add | add | add | add | add | add | add | add |
| | pH 8 | pH 8 | pH 8 | pH 8 | pH 8 | pH 8 | pH 8 | pH 8 |

The following examples shall further illustrate the present invention without restricting the scope of the invention.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### EXAMPLES

### Synthesis Examples

In the following, “EO/NH” means ethylene oxide (EO) repeating units per NH-functionality of the (backbone-modified) polyalkylene imine, “PO/NH” means propylene oxide (PO) repeating units 5 per NH-functionality of the (backbone-modified) polyalkylene imine. The term “Mw/Mn” has the meaning known in the art. The terms “example” and “product” may be used interchangeably. Abbreviations used, in particular in the Tables: MCDA=methylcyclohexane diamine; N3-Amine=3-(2-aminoethylamino)propylamine; N4-Amine=N,N-Bis-(3-aminopropyl)-ethylenediamine LOM=launder-o-meter.

### 1) Examples 1-20 According to the Second Intermediate (I2)

TABLE 5
Overview of prepared nitrogen-containing polymers according
to the second intermediate (I2) without alkoxylation

| | | Bisglycidyl or | Molar ratio | Preparation |
|---|---|---|---|---|
| Example | Amine | diol basis | NH/Bisglycidylether | procedure |
| 1 | MCDA | Butane | 2/1.2 | A |
| 2 | N3-Amine | Butane | 2/1.2 | B |
| 3 | N3-Amine | Butane | 2/1.4 | B |
| 4 | N3-Amine | Hexane | 2/1.2 | C |
| 5 | N4-Amine | Butane | 2/1 | A |
| 6 | N4-Amine | Butane | 2/1.2 | A |
| 7 | Triethylentetramin | Butane | 2/1.3 | E |
| | (TETA) | | | |
| 8 | N4-Amine | Hexane | 2/1.2 | C |
| 9 | N4-Amine | Hexane | 2/1.3 | C |
| 10 | Tris(2- | Hexane | 2/1.1 | E |
| | aminoethyl)amine | | | |
| 11 | DETA (Diethylentri- | Hexane | 2/1.3 | C |
| | amine) | | | |
| 12 | DETA | NPG | 2/1.3 | C |
| 13 | DETA | Cyclohexan- | 2/1.3 | C |
| | | dimethanol | | |
| 14 | Hexatran | Butane | 2/1.0 | E |
| 15 | Hexatran | Butane | 2/1.3 | E |
| 16 | TEPA (Tetra- | Butane | 2/1.0 | D |
| | ethylenpentamin) | | | |
| 17 | TEPA (Tetra- | Butane | 2/1.1 | D |
| | ethylenpentamin) | | | |
| 18 | TEPA (Tetra- | Diglycidylether | 2/1.3 | D |
| | ethylenpentamin) | | | |
| 19 | PEHA (Pen- | Ethylene | 2/1.25 | D |
| | taethylenhexamin) | glycol | | |
| 20 | PEHA (Pen- | Butane | 2/1.25 | D |
| | taethylenhexamin) | | | |

TABLE 6
Overview of the properties of Examples 1-20

| | | | | No. of | |
|---|---|---|---|---|---|
| | | | | primary | No. of secondary |
| Example | Mn | Mw/Mn | OH-number | amines | amines |
| 1 | 1460 | 4.8 | 183 | 188 | 374 |
| 2 | 1050 | 4.1 | 201 | 273 | 418 |
| 3 | 1440 | 4.4 | 196 | 284 | 429 |
| 4 | 1280 | 4.6 | 205 | 197 | 405 |
| 5 | 585 | 3.7 | 199 | 277 | 425 |
| 6 | 1090 | 3.3 | 211 | 247 | 402 |
| 7 | 1630 | 4.2 | 215 | 283 | 407 |
| 8 | 569 | 6.4 | 202 | 214 | 423 |
| 9 | 578 | 7 | 221 | 195 | 426 |
| 10 | 1310 | 5.1 | 209 | 301 | 264 |
| 11 | 930 | 4.8 | 198 | 201 | 400 |
| 12 | 1260 | 4.3 | 195 | 216 | 393 |
| 13 | 940 | 4.8 | 187 | 192 | 375 |
| 14 | 749 | 2.2 | 179 | 306 | 284 |
| 15 | 1070 | 4.9 | 206 | 281 | 245 |
| 16 | 380 | 4.7 | 238 | 295 | 382 |
| 17 | 435 | 5.8 | 236 | 278 | 378 |
| 18 | 1250 | 4.1 | 227 | 305 | 370 |
| 19 | 970 | 5.4 | 204 | 284 | 364 |
| 20 | 1160 | 3.9 | 221 | 270 | 358 |

In the following the preparation procedures A to D for Examples 1-20 are given:

### Procedure A

Reaction of N4-Amin with BDBGE (Example for Amine:BGE of 2:1,20)

In a 500 mL 4-neck flask equipped with a reflux condenser and dropping funnel are placed N,N′-Bis-(3-aminopropyl)-1,2-diaminoethane 120 g (0.69 mol) and warmed in an oil bath to 50° C. Via the dropping funnel 1,4-butanediolbisglycidylether 83.55 g (0.41 mol) is added slowly. An exothermic reaction occurs and the dosing speed is adjusted to maintain the temperature below 90° C. After approx. 1.5 h the full amount of 1,4-butanediolbisglycidylether has been added and the reaction mixture shows a clear increase in viscosity. The reaction mixture is kept at 70° C. for another 1 h and is the allowed to cool to RT. 203.55 g of a highly viscous liquid is obtained.

### Procedure B

Reaction of N3-Amin with BDBGE (Example for Amine:BGE of 2:1.40)

In a 250 mL HWS flask equipped with an anchor stirrer 73.72 g (629 mmol) N,N′-Bis-(3-aminopropyl)-1,2-diaminoethane are introduced and warmed to 55° C. Under stirring at 110 rpm 1,4-Butandiolbisglycidylether is added via a peristaltic pump at a dosage rate of 2 mL/min until exothermic reaction is observed. Until this point approx. 20 g of BDBGE has to be added. The rate of dosage is reduced from 2 mL/min to 1 mL/min and the remaining amount of 1,4-butandiolbisglycidylether is added under cooling over the course of approx. 1.5 h at a temperature of 55° C. After completion 90.44 g 1,4-butandiolbisglycidylether (440 mmol) have been added. The reaction mixture is kept at 55° C. for another 1 h and then allowed to cool to RT to yield 164 g of a highly viscous liquid.

### Procedure C

Reaction of N4-Amin with EGBGE or HDBGE (Example for Amine:BGE (EGBGE) of 2:1,30)

In a 250 mL Systag glass reactor (FlexyCUBE System) with an anchor stirrer 123.99 g (711 mmol) N,N′-Bis-(3-aminopropyl)-1,2-diaminoethane are introduced and warmed to 60° C. Under stirring at 100 rpm 10.0 g 1,2-Ethylenediolbisglycidylether is added via a peristaltic pump at a dosage rate of 1 g/min until exothermic reaction is observed. Dosing of 70.55 g EGBGE is continued at a rate of 1 g/min allowing a maximum of ΔT of 20° C., otherwise the dosing rate is reduced to 0.8 g/min. If ΔT should rise to 25° C. the dosing rate is reduced to 0.5 g/min. After completion 80.55 g Ethylenglycolbisglycidylether (462 mmol) has been added, the reaction mixture is kept at 60° C. for another 2 hours and then allowed to cool down to RT to yield 205 g of a highly viscous liquid.

### Procedure D

Reaction of Tetraethylenpentamin (TEPA) with BDBGE (Example for Amine:BGE of 2:1,0)

In a 250 mL Systag glass reactor (FlexyCUBE System) with an anchor stirrer 91.26 g (482 mmol) TEPA diluted with 60 g of methanol are introduced and the mixture is warmed to 60° C. Under stirring at 100 rpm 48.74 g (214 mmol) BDBGE is added via a peristaltic pump at a dosage rate of 1 g/min allowing a maximum ΔT of 20° C., otherwise the dosing rate is reduced to 0.8 g/min. If ΔT should rise to 25° C. the dosing rate is reduced to 0.5 g/min. After completion, the reaction mixture is kept at 60° C. for another 2 hours and then allowed to cool down to RT. The organic solvent is destilled off under vacuum till 5 mbar and 80° C. Finally 140 g of a highly viscous liquid is obtained.

### Procedure E

Reaction of 4-Aminomethyl-1,8-Octandiamin (Hexatran) with BDBGE (Example for Amine:BGE of 2:1,0)

In a 500 mL 4-neck flask equipped with a reflux condenser and dropping funnel are placed 4-Aminomethyl-1,8-octandiamin 186.42 g (1.08 mol) and the amine is warmed in an oil bath to 80° C. Via the dropping funnel 1,4-butanediolbisglycidylether 108.78 g (0.41 mol) is added slowly. An exothermic reaction occurs and the dosing speed is adjusted to maintain the temperature below 90° C. After approx. 1.5 h the full amount of 1,4-butanediolbisglycidylether has been added and the reaction mixture shows a clear increase in viscosity. The reaction mixture is kept at 80° C. for another 2 h and is the allowed to cool to RT. 295 g of a highly viscous liquid is obtained.

### 2) Alkoxylation of the Examples 1-20 Resulting in Examples 21-52

TABLE 7
Overview of the alkoxylated Examples 21-52

| Example | Basis for the core | EO/NH | PO/NH |
|---|---|---|---|
| 21 | 1 | 25 | — |
| 22 | 1 | 25 | 16 |
| 23 | 2 | 30 | — |
| 24 | 2 | 30 | 24 |
| 25 | 3 | 30 | 30 |
| 26 | 3 | 20 | — |
| 27 | 4 | 20 | — |
| 28 | 4 | 30 | 3 |
| 29 | 4 | 30 | 24 |
| 30 | 5 | 25 | — |
| 31 | 6 | 20 | 24 |
| 32 | 7 | 30 | — |
| 33 | 7 | 30 | 30 |
| 34 | 8 | 30 | — |
| 35 | 9 | 25 | 24 |
| 36 | 10 | 25 | — |
| 37 | 10 | 25 | 16 |
| 38 | 11 | 20 | 20 |
| 39 | 12 | 30 | 16 |
| 40 | 13 | 30 | 30 |
| 41 | 14 | 30 | — |
| 42 | 14 | 25 | 16 |
| 43 | 15 | 20 | — |
| 44 | 15 | 20 | 16 |
| 45 | 16 | 20 | — |
| 46 | 17 | 25 | — |
| 47 | 18 | 30 | |
| 48 | 18 | 30 | 24 |
| 49 | 19 | 25 | — |
| 50 | 19 | 25 | 30 |
| 51 | 20 | 30 | — |
| 52 | 20 | 30 | 16 |

TABLE 8
Overview of the properties of Examples 21-52

| | Molecular | | | |
|---|---|---|---|---|
| Example | weight Mn | Mw/Mn | Amin numbers | OH numbers |
| 21 | 8.200 | 4.1 | 30 | 65 |
| 22 | 14000 | 3.9 | 17 | 35 |
| 23 | 7.100 | 3.7 | 21 | 45 |
| 24 | 14.200 | 3.6 | 11 | 22 |
| 25 | 18.800 | 3.8 | 10 | 16 |
| 26 | 6.450 | 4.2 | 27 | 55 |
| 27 | 6.100 | 4.3 | 32 | 67 |
| 28 | 9.700 | 4.0 | 24 | 45 |
| 29 | 14.400 | 3.7 | 12 | 21 |
| 30 | 9.650 | 3.5 | 27 | 61 |
| 31 | 15.100 | 4.0 | 23 | 59 |
| 32 | 14.300 | 3.6 | 22 | 44 |
| 33 | 27.400 | 3.3 | 9 | 17 |
| 34 | 7.850 | 4.7 | 21 | 42 |
| 35 | 14.800 | 4.5 | 15 | 25 |
| 36 | 9.950 | 4.8 | 31 | 64 |
| 37 | 16.780 | 4.4 | 16 | 36 |
| 38 | 14.900 | 4.3 | 17 | 35 |
| 39 | 21.850 | 3.7 | 11 | 21 |
| 40 | 23.900 | 4.0 | 8 | 16 |
| 41 | 14.500 | 3.3 | 22 | 43 |
| 42 | 18.800 | 3.1 | 15 | 34 |
| 43 | 11.600 | 4.2 | 32 | 63 |
| 44 | 20.450 | 4.1 | 18 | 38 |
| 45 | 8.600 | 4.8 | 33 | 65 |
| 46 | 11.100 | 4.2 | 31 | 62 |
| 47 | 13.300 | 3.7 | 21 | 42 |
| 48 | 22.500 | 3.5 | 12 | 21 |
| 49 | 11.550 | 4.2 | 30 | 62 |
| 50 | 23.400 | 3.8 | 13 | 21 |
| 51 | 14.200 | 3.4 | 20 | 43 |
| 52 | 22.650 | 3.4 | 10 | 22 |

In the following the alkoxylation protocols are given:

### Product 21

A 2-liter steel autoclave was charged with 100 g backbone 1. An amount of 3.3 g of KOH (50%) was added and the mixture was heated to 130° C. under stirring. Then, 34 g of ethylene oxide were fed into the autoclave within 10 minutes. The start of an exothermic reaction was observed. Subsequently, 698 g of ethylene oxide were fed into the autoclave within 13.5 hours, total amount of 10 molEO/OH. The reaction mixture was stirred at 130° C. for further 6 hours.

After that, the mixture was removed from the autoclave and residual EO and water were stripped under reduced pressure (20 mbar) at 80° C. for two hours. 831 g of an ethoxylate was obtained as an orange liquid, total amine value: 61.0 mg KOH/g, OH value: 142 mg KOH/g.

### Product 21 a (10 EO/Total OH—NH)

### Further Ethoxylation to Obtain 25 EO/OH

A 2-liter steel autoclave was charged with 550 g of product 21a. An amount of 5.5 g of KOH (50%) was added and the mixture was heated to 130° C. under stirring. Then, 53 g of ethylene oxide were fed into the autoclave within 15 minutes. The start of an exothermic reaction was observed. Subsequently, 770 g of ethylene oxide were fed into the autoclave within 16 hours, total amount of 15 molEO/OH to obtain at the end 25EO/OH. The reaction mixture was stirred at 130° C. for further 6 hours. After that, the mixture was removed from the autoclave and residual EO and water were stripped under reduced pressure (20 mbar) at 80° C. for two hours. 1371 g of product 21 was obtained as a beige solid, total amine value: 30 mg KOH/g, OH value: 65 mg KOH/g. (product 21)

Product 22: Propoxylation of Product 21 with 16 PO/OH—NH

A 2-liter steel autoclave was charged with 300 g of the above ethoxylate (product 21) and 2.2 g of KOH (50%) and heated to 130° C. under stirring with 100 rpm. Then, 34 g of propylene oxide were added within 15 minutes and stirred at 130° C. and 211 g were added within 4.5 h under increased stirrer speed, 200 rpm, and the reaction continues for another 6 hours. Then, the reaction mixture was slowly cooled down. Polymer 22 was collected as a brown liquid (545 g). Total amine value: 17 mg KOH/g, OH value: 35 mg KOH/g. (product 22)

### Product 23

A 2-liter steel autoclave was charged with 100 g backbone 2. An amount of 4.0 g of KOH (50%) was added and the mixture was heated to 130° C. under stirring. Then, 34 g of ethylene oxide were fed into the autoclave within 10 minutes. The start of an exothermic reaction was observed. Subsequently, 880 g of ethylene oxide were fed into the autoclave within 13.5 hours, total amount of 10 molEO/OH. The reaction mixture was stirred at 130° C. for further 6 hours. After that, the mixture was removed from the autoclave and residual EO and water were stripped under reduced pressure (20 mbar) at 80° C. for two hours. 1014 g of an ethoxylate was obtained as an orange liquid, total amine value: 62.0 mg KOH/g, OH value: 130 mg KOH/g. (product 23a)

### Further Ethoxylation of 23a to Obtain 30 EO/OH—NH in Backbone 2

A 2-liter steel autoclave was charged with 550 g of product 23a. An amount of 6.2 g of KOH (50%) was added and the mixture was heated to 130° C. under stirring. Then, 53 g of ethylene oxide were fed into the autoclave within 15 minutes. The start of an exothermic reaction was observed. Subsequently, 938 g of ethylene oxide were fed into the autoclave within 16 hours, total amount of 20 molEO/OH to obtain at the end 30EO/OH. The reaction mixture was stirred at 130° C. for further 6 hours. After that, the mixture was removed from the autoclave and residual EO and water were stripped under reduced pressure (20 mbar) at 80° C. for two hours. 1541 g of product 23 was obtained as a beige solid, total amine value: 21 mg KOH/g, OH value: 45 mg KOH/g. (product 23)

### Example 24

Propoxylation of Product 23 with 24 PO/OH—NH

A 2-liter steel autoclave was charged with 300 g of the above ethoxylate 23 and 2.4 g of KOH (50%) and heated to 130° C. under stirring with 100 rpm. Then, 34 g of propylene oxide were added within 15 minutes and stirred at 130° C. and 268 g were added within 4.5 h under increased stirrer speed, 200 rpm, and the reaction continues for another 6 hours. Then, the reaction mixture was slowly cooled down. Polymer 24 was collected as a brown liquid (602 g). Total amine value: 11 mg KOH/g, OH value: 22 mg KOH/g. (product 24)

### Product 25

### Further Ethoxylation of 26a to Obtain 30EO/OH—NH of Backbone 3 (Product 25a)

A 2-liter steel autoclave was charged with 500 g of product 26a. An amount of 5.5 g of KOH (50%) was added and the mixture was heated to 130° C. under stirring. Then, 48 g of ethylene oxide were fed into the autoclave within 15 minutes. The start of an exothermic reaction was observed. Subsequently, 844 g of ethylene oxide were fed into the autoclave within 15 hours. The reaction mixture was stirred at 130° C. for further 6 hours. After that, the mixture was removed from the autoclave and residual EO and water were stripped under reduced pressure (20 mbar) at 80° C. for two hours. 1387 g of an ethoxylate was obtained as a beige solid, total amine value: 19 mg KOH/g, OH value: 38 mg KOH/g. (product 25a)

### Propoxylation of Product 25a to Obtain Product 25

A 2-liter steel autoclave was charged with 300 g of the above ethoxylate (400) and 2.7 g of KOH (50%) and heated to 130° C. under stirring with 100 rpm. Then, 34 g of propylene oxide were added within 15 minutes and stirred at 130° C. and 347 g were added within 4.5 h under increased stirrer speed, 200 rpm, and the reaction continues for another 6 hours. Then, the reaction mixture was slowly cooled down. Polymer 25 was collected as a brown liquid (681 g). Total amine value: 10 mg KOH/g, OH value: 16 mg KOH/g. (product 25)

### Product 26

A 2-liter steel autoclave was charged with 100 g backbone 3. An amount of 3.6 g of KOH (50%) was added and the mixture was heated to 130° C. under stirring. Then, 52 g of ethylene oxide were fed into the autoclave within 15 minutes. The start of an exothermic reaction was observed. Subsequently, 884 g of ethylene oxide were fed into the autoclave within 12.5 hours, total amount of 10 molEO/OH. The reaction mixture was stirred at 130° C. for further 6 hours. After that, the mixture was removed from the autoclave and residual EO and water were stripped under reduced pressure (20 mbar) at 80° C. for two hours. 1040 g of an ethoxylate was obtained as an orange liquid, total amine value: 54 mg KOH/g, OH value: 108 mg KOH/g. (product 26a)

Further Ethoxylation 26a to Obtain Product 26 with 20 EO/OH—NH pf Backbone 3

A 2-liter steel autoclave was charged with 540 g of product 26a. An amount of 4.0 g of KOH (50%) was added and the mixture was heated to 130° C. under stirring. Then, 48 g of ethylene oxide were fed into the autoclave within 15 minutes. The start of an exothermic reaction was observed. Subsequently, 448 g of ethylene oxide were fed into the autoclave within 7 hours. The reaction mixture was stirred at 130° C. for further 6 hours. After that, the mixture was removed from the autoclave and residual EO and water were stripped under reduced pressure (20 mbar) at 80° C. for two hours. 1036 g of product 26 was obtained as a beige solid, total amine value: 27.0 mg KOH/g, OH value: 55 mg KOH/g. (product 26)

The rest of the examples have been synthesized like described above. Here a brief protocol is described:
1. First alkoxylation of the backbone with 10/EO per total OH—NH number starting with 100 g Material of the product (see last columns of Table 8).
2. Second further alkoxylation according to the corresponding amount of EO starting with 550 g material of the product.
3. Propoxylation of the product obtained in step 2 with the corresponding amount of PO starting with 300 g material of the product.
4. In each alkoxylation step pure 0.2% KOH has been used as a catalysator referred to the final amount of product obtained in the respective step.
5. All alkoxylation reactions have been carried out at 130° C.

In all cases >98% yield have been obtained

### 3) Application Experiments

Table 9 shows the base liquid laundry detergent w/o any polymer (LLD.1) that has been used to carry out the application tests to determine the impact of the inventive polymers on the primary cleaning performance.

TABLE 9
Composition of the base liquid laundry detergent.

| Ingredients | LLD.1 * |
|---|---|
| Linear C₁₂C₁₄-alkylbenzenesulfonic acid | 5.50 |
| C₁₂-fatty alcohol × 2 EO sulfate | 5.40 |
| C₁₂C₁₅-fatty alcohol × 7 EO | 5.40 |
| Coconut C12-C18 fatty acid | 2.40 |
| Sodium hydroxide | 2.20 |
| 1,2-Propylene glycol | 6.00 |
| Ethanol | 2.00 |
| Sodium citrate | 3.00 |
| Demin. water | add 100 |
| pH value | 8.5 |

*) All data are wt % active ingredient, independent of the respective product form.

### Primary Cleaning Performance on Particulate Stains

To determine the primary detergency, the cleaning performance on 4 different particulate stains on a polyester fabric (CFT, Vlaardingen, The Netherlands) was measured by determining the color difference (delta E) between the stains after wash and the unsoiled white fabric using a reflectometer (Mach5 plus, a multi area color measurement instrument from ColourConsult). Each experiment containing the 4 different circular particulate stains (Clay ground soil, Standard clay, Red pottery clay, Tennis court clay; All 4 stains on one polyester fabric, 2 of those fabrics per wash) was repeated 3 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive modified hyperbranched alkoxylated polyalkylene imine or the comparative polymer, respectively, vs. the laundry detergent w/o any modified hyperbranched alkoxylated polyalkylene imine or comparative polymer, respectively.

Table 10 shows the washing test conditions and Table 11 summarizes the obtained standardized cleaning performance. The standardized cleaning performance shown in Table 13 is the sum of the standardized cleaning performance of all 4 stains. The bigger the sum of the delta delta E value, the bigger the positive contribution of the inventive alkoxylated nitrogen containing polymer or the comparative polymer, respectively, vs. the laundry detergent w/o any alkoxylated nitrogen containing polymer or comparative polymer, respectively, on the cleaning performance. Reference 1 (Ref. 1) corresponds to ethoxylated polyethylene imine (PEI) commercially available from BASF under its trademark name Sokalan® HP20.

TABLE 10
Washing conditions for evaluation of primary cleaning performance on particulate stains.
Washing conditions

| | |
|---|---|
| Device | Launder-O-Meter from SDL Atlas, Rock Hill, |
| | USA |
| Washing liquor | 250 mL |
| Washing time | 30 minutes |
| Washing temperature | 30° C. |
| Detergent concentration | 3.0 g/L |
| Water hardness (Ca:Mg:HCO3) | 1.2 mmol/L (4:1:8) (7°dH) |
| Fabric to liquor ratio | 1:10 |
| Alkoxylated nitrogen containing polymer or | 3% by weight (vs. liquid laundry detergent) of |
| comparative polymer, respectively | the polymer, 100% active ingredient |
| Test fabric * | 4 different circular particulate stains (P- |
| | H018, P-H115, P-H144, P-H145) (CFT, |
| | Vlaardingen, The Netherlands) on one polyester |
| | fabric; 2 stained fabrics per wash |
| Ballast fabric | 2.5 g SBL 2004 (Soil Ballast Fabric ‘Formula |
| | 2004’ that simulates sebum grease stains; |
| | WFK Testgewebe GmbH, Brueggen, Germany); + |
| | additional white cotton ballast |

*) After the washing experiment, the test fabrics were rinsed with tap water followed by drying at ambient room temperature overnight, prior to the measurement with the Mach5 plus.

TABLE 11
Results from washing tests (primary cleaning
performance on particulate stains).

| | | Concentration of | Standardized cleaning |
|---|---|---|---|
| | Polymer | polymeric | performance (sum delta |
| Detergent | (Example) | additive * | delta E) |
| LLD.1 | Ref. 1 | 3 wt % | 9.3 |
| LLD.1 | 19 | 3 wt % | 10.8 |
| LLD.1 | 21 | 3 wt % | 11.9 |
| LLD.1 | 24 | 3 wt % | 12.5 |
| LLD.1 | 25 | 3 wt % | 11.8 |
| LLD.1 | 26 | 3 wt % | 12.9 |
| LLD.1 | 28 | 3 wt % | 13.5 |
| LLD.1 | 30 | 3 wt % | 13.5 |
| LLD.1 | 32 | 3 wt % | 14.2 |
| LLD.1 | 34 | 3 wt % | 13.1 |
| LLD.1 | 39 | 3 wt % | 11.4 |
| LLD.1 | 41 | 3 wt % | 14.8 |
| LLD.1 | 43 | 3 wt % | 12.4 |
| LLD.1 | 44 | 3 wt % | 13.1 |
| LLD.1 | 45 | 3 wt % | 12.5 |

*) All data are wt % active ingredient, independent of the respective product form.

### Test Results:

The error of the measurement is +/−2 delta delta E units. Therefore, any value >2 (sum delta delta E) means that the respective polymer exhibits a directional and visible contribution to the overall cleaning performance of the respective detergent formulation; Any value >4 (sum delta delta E) means that the respective polymer exhibits even a significant contribution to the overall cleaning performance, i.e., the respective polymer leads to a significant improvement of the formulation. All polymers (inventive and comparative) exhibit significant cleaning benefits on particulate stains.

The wash performance of the alkoxylated nitrogen containing polymer samples 19, 21, 24, 25, 26, 28, 30, 32, 34, 39, 41, 43, 44 and 45 was improved over Sokalan® HP20 (Ref.1), considering the error of the measurement.

### Primary Cleaning Performance on Oily/Fatty Stains

To determine the primary detergency, the cleaning performance on 16 different oily/fatty stains on cotton, polycotton and polyester fabrics (CFT, Vlaardingen, The Netherlands) was measured by determining the color difference (delta E) between the stains after wash and the unsoiled white fabric using a reflectometer (Mach5 plus, a multi area color measurement instrument from ColourConsult). Each experiment containing the 16 different circular oily/fatty stains (Lipstick, Make-Up, Beef Fat, Frying Fat, Burnt Butter, Palm Oil, Sebum BEY, Sebum Tefo, Collar Stain; All on different fabrics) was repeated 6 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive alkoxylated nitrogen containing polymer or the comparative polymer, respectively, vs. the laundry detergent w/o any alkoxylated nitrogen containing polymer or comparative polymer, respectively.

Table 12 shows the washing test conditions and Table 15 summarizes the obtained standardized cleaning performance. The standardized cleaning performance shown in Table 13 is the sum of the standardized cleaning performance of all 16 stains. The bigger the sum of the delta delta E value, the bigger the positive contribution of the inventive alkoxylated nitrogen containing polymer or the comparative polymer, respectively, vs. the laundry detergent w/o any alkoxylated nitrogen containing polymer or comparative polymer, respectively, on the cleaning performance. Reference 2 (Ref. 2) corresponds to ethoxylated and propoxylated triethylamine (TEA). In detail, the polymer is TEA+20EO+30PO with Mn 2.400. Reference 3 (Ref. 3) corresponds to ethoxylated and propoxylated polyethylene imine (PEI). In detail, the polymer is PEI800+30EO+24PO with a number average molecular weight (Mn) of 800 g/mol.

TABLE 12
Washing conditions for evaluation of primary cleaning performance on oily/fatty stains.
Washing conditions

| | |
|---|---|
| Device | Launder-O-Meter from SDL Atlas, Rock Hill, USA |
| Washing liquor | 250 mL |
| Washing time | 60 minutes |
| Washing temperature | 30° C. |
| Detergent concentration | 3.0 g/L |
| Water hardness (Ca:Mg:HCO3) | 2.5 mmol/L (4:1:8) (14°dH) |
| Fabric to liquor ratio | 1:10 |
| Alkoxylated nitrogen containing | 2.83% by weight (vs. liquid laundry detergent) of the |
| polymer or comparative polymer, | polymer, 100% active ingredient |
| respectively | |
| Test fabric * | 16 different circular oily/fatty stains (KC-H122, KC-H176, |
| | KC-H015, KC-H187, PC-H082, PC-H212, PC-H210, PC- |
| | H252, P-H122, P-H129, P-H015, P-H187, P-H082, P- |
| Ballast fabric | H212, P-H210, P-H252) (CFT, Vlaardingen, The |
| | Netherlands) |
| | Polyester and cotton ballast, to yield a 1:1 ratio of |
| | polyester/cotton fabric per experiment |

*) After the washing experiment, the test fabrics were rinsed with 14°dH water (2 times), followed by drying at ambient room temperature overnight, prior to the measurement with the Mach5 plus.

TABLE 13
Results from washing tests (primary cleaning
performance on oily/fatty stains).

| | | Concentration of | Standardized cleaning |
|---|---|---|---|
| | Polymer | polymeric | performance (sum delta |
| Detergent | (Example) | additive * | delta E) |
| LLD.1 | Ref. 2 | 2.5 wt % | 57.1 |
| LLD.1 | Ref. 3 | 2.5 wt % | 62.4 |
| LLD.1 | 20 | 2.5 wt % | 66.3 |
| LLD.1 | 22 | 2.5 wt % | 70.5 |
| LLD.1 | 23 | 2.5 wt % | 74.0 |
| LLD.1 | 27 | 2.5 wt % | 71.8 |
| LLD.1 | 29 | 2.5 wt % | 69.0 |
| LLD.1 | 31 | 2.5 wt % | 76.3 |
| LLD.1 | 33 | 2.5 wt % | 73.1 |
| LLD.1 | 35 | 2.5 wt % | 71.9 |
| LLD.1 | 36 | 2.5 wt % | 72.8 |
| LLD.1 | 37 | 2.5 wt % | 72.0 |
| LLD.1 | 38 | 2.5 wt % | 74.6 |
| LLD.1 | 40 | 2.5 wt % | 78.1 |
| LLD.1 | 42 | 2.5 wt % | 73.5 |
| LLD.1 | 46 | 2.5 wt % | 75.3 |

*) All data are wt % active ingredient, independent of the respective product form.

### Test Results:

The error of the measurement is +/−10 delta delta E units. Therefore, any value >10 (sum delta delta E) means that the respective polymer exhibits a directional and visible contribution to the overall cleaning performance of the respective detergent formulation; Any value >15 (sum delta delta E) means that the respective polymer exhibits even a significant contribution to the overall cleaning performance, i.e., the respective polymer leads to a significant improvement of the formulation. All polymers (inventive and comparative) exhibit significant cleaning benefits on oily/fatty stains.

The wash performance of the alkoxylated nitrogen containing polymer samples 20, 22, 23, 27, 29, 31, 33, 35, 36, 37, 38, 40, 42 and 46 was improved over the reference sample Ref.2 as well as Ref. 3, considering the error of the measurement.

1. An alkoxylated nitrogen containing polymer obtained by a process comprising the following steps:
a) optionally reacting (i) at least one di- or polyol with (ii) epichlorohydrin in order to obtain a first intermediate (I1),
b) reacting (i) a di- or oligoamine (A) with (iia) the first intermediate (I1) or (iib) a compound comprising at least two glycidyl ether groups in order to obtain a second intermediate (I2), and
c) reacting the second intermediate (I2) with an alkylene oxide (AO) selected from the group consisting of ethylene oxide (EO), propylene oxide (PO) or both and optionally butylene oxide and/or at least one lactone (LA) and/or at least one hydroxy carbon acid (HA), wherein at least 15.0 mol of the alkylene oxide (AO) is employed per mol of NH- and OH-functionality of second intermediate (I2),
in order to obtain alkylene oxide side chains (AB) linked to nitrogen atoms and —OH groups of the second intermediate (I2) providing the alkoxylated nitrogen containing polymer,
wherein the nitrogen mass content of the di- or oligoamine (A) ranges from 20 to 50%.

2. The alkoxylated nitrogen containing polymer according to claim 1, wherein the at least one di- or oligoamine (A)
(i) has at least 2 amino groups;
(ii) has at least one carbon atom per nitrogen atom;
(iii) comprises at least two primary and/or secondary amino groups;
(iv) has a molecular weight (Mw) that lies in the range of from 50 to 500 g/mol; and/or
(v) is selected from the group consisting of ethylenediamine, hexamethylenediamine, methylcyclohexane diamine (MCDA), propylenediamine (PDA), tetramethylenediamine (TMDA), pentamethylenediamine (PMDA), dipropylenetriamine (DPTA), tripropylene-tetramine (TPTA), tris(2-aminoethyl)amine (TAEA), tetrapropylenpentamin (TPPA), N,N′-Bis-(3-aminopropyl)ethylenediamine (N4-amine), 3-(2-aminoethylamino)propylamine (N3-amine), spermine, spermidine, triamino nonane, diethylentriamin (DETA), triethylentetramine (TETA), tetraethylenpentamine (TEPA), pentaethylenhexamine (PEHA) and compounds according to Formulas (II) to (X),

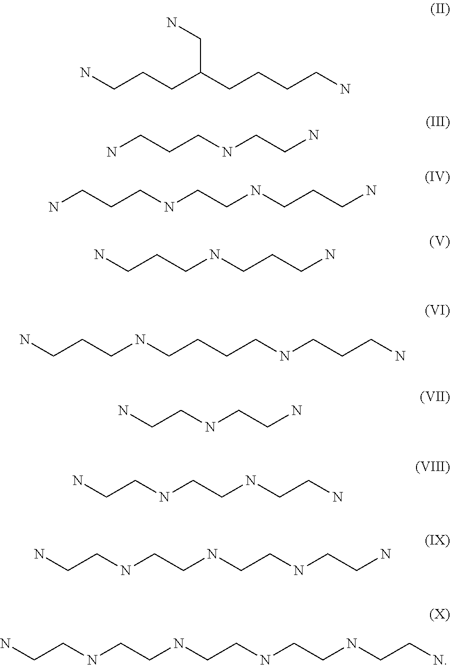

3. The alkoxylated nitrogen containing polymer according to claim 1, wherein the compound comprising at least two glycidyl ether groups
(i) comprises at least two times a structure according to formula (I) 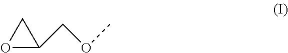
wherein the dotted line indicates bond to the remaining part of the compound comprising at least two glycidyl ether groups; and/or
(ii) is selected from the group consisting of 1,4-butandiol bisglycidyl ether, 1,6-hexanediol bisglycidyl ether, diglycidyl ether, 1,3-neopentylglycol bisglycidyl ether, 1,4-cyclohexanedimethanol bisglycidyl ether, ethylene glycol bisglycidyl ether, glycerin triglycidyl ether and trimethylolpropane triglycidyl ether.

4. The alkoxylated nitrogen containing polymer according to claim 1, wherein the di- or polyol is selected from the group consisting of 1,4-butandiol, 1,6-hexanediol, 1,3-neopentylglycol, 1,4-cyclohexanedimethanol, glycerin and trimethylolpropane.

5. The alkoxylated nitrogen containing polymer according to claim 1, wherein the alkoxylated nitrogen containing polymer comprises a structural element according to Formula (XI) 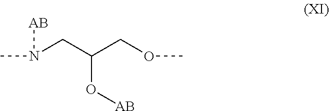
wherein
the dotted lines indicate bonds to the remaining parts of the alkoxylated nitrogen containing polymer; and
AB represent one alkylene oxide side chain.

6. The alkoxylated nitrogen containing polymer according to claim 1, wherein the alkoxylated nitrogen containing polymer is
(i) soluble in water; and/or
(ii) a polymer based on a branched second intermediate (I2).

7. The alkoxylated nitrogen containing polymer according to claim 1, wherein the weight average molecular weight (Mw) of the alkoxylated nitrogen containing polymer lies in the range of from 500 to 150 000 g/mol.

8. The alkoxylated nitrogen containing polymer according to claim 1, wherein up to 50% of the nitrogen atoms present in the alkoxylated nitrogen containing polymer are further quaternized.

9. The alkoxylated nitrogen containing polymer according to claim 1, wherein
i) the lactone (LA) is selected from the group consisting of caprolactone, g- or d-valerolactone, and lactide, and/or
ii) the hydroxy carbon acid (HA) is selected from the group consisting of lactic acid and glycolic acid.

10. The alkoxylated nitrogen containing polymer according to claim 1, wherein
i) in step c) in total 5 to 100 mol of alkylene oxide (AO) is employed per mol of NH- and OH-functionality of second intermediate (I2), wherein more than 50 mol % of the alkylene oxide is based on ethylene oxide, or
ii) in step c) in total 25 to 120 mol of alkylene oxide (AO) is employed per mol of NH- and OH-functionality of second intermediate (I2), wherein less than 80 mol % of the alkylene oxide is based on ethylene oxide.

11. The alkoxylated nitrogen containing polymer according to claim 1, wherein
(1) in step b) the di- or oligoamine (A) is methylcyclohexane diamine (MCDA) and the compound comprising at least two glycidyl ether groups is 1,4-butandiol bisglycidyl ether; and
in step c) at least 25 mol of ethylene oxide and optionally at least 16 mol of propylene oxide is employed per mol of NH- and OH-functionality of second intermediate (I2); or
(2) in step b) the di- or oligoamine (A) is 3-(2-aminoethylamino)propylamine (N3-amine) and the compound comprising at least two glycidyl ether groups is 1,4-butandiol bisglycidyl ether; and
in step c) at least 20 mol of ethylene oxide and optionally at least 3 mol of propylene oxide is employed per mol of NH- and OH-functionality of second intermediate (I2); or
(3) in step b) the di- or oligoamine (A) is N,N′-Bis-(3-aminopropyl)ethylenediamine (N4-amine) and the compound comprising at least two glycidyl ether groups is 1,4-butandiol bisglycidyl ether or 1,6-hexanediol bisglycidyl ether; and
in step c) at least 20 mol of ethylene oxide and optionally at least 24 mol of propylene oxide is employed per mol of NH- and OH-functionality of second intermediate (I2); or
(4) in step b) the di- or oligoamine (A) is triethylentetramine (TETA) and the compound comprising at least two glycidyl ether groups is 1,4-butandiol bisglycidyl ether; and
in step c) at least 30 mol of ethylene oxide and optionally at least 30 mol of propylene oxide is employed per mol of NH- and OH-functionality of second intermediate (I2); or
(5) in step b) the di- or oligoamine (A) is tris(2-aminoethyl)amine (TAEA) and the compound comprising at least two glycidyl ether groups is 1,6-hexanediol bisglycidyl ether; and
in step c) at least 25 mol of ethylene oxide and optionally at least 16 mol of propylene oxide is employed per mol of NH- and OH-functionality of second intermediate (I2); or
(6) in step b) the di- or oligoamine (A) is diethylentriamin (DETA) and the compound comprising at least two glycidyl ether groups is 1,6-hexanediol bisglycidyl ether, 1,3-neopentylglycol bisglycidyl ether or 1,4-cyclohexanedimethanol bisglycidyl ether; and
in step c) at least 20 mol of ethylene oxide and optionally at least 16 mol of propylene oxide is employed per mol of NH- and OH-functionality of second intermediate (I2); or
(7) in step b) the di- or oligoamine (A) is triamino nonane and the compound comprising at least two glycidyl ether groups is 1,4-butandiol bisglycidyl ether; and
in step c) at least 25 mol of ethylene oxide and optionally at least 16 mol of propylene oxide is employed per mol of NH- and OH-functionality of second intermediate (I2); or
(8) in step b) the di- or oligoamine (A) is tetraethylenpentamine (TEPA) and the compound comprising at least two glycidyl ether groups is 1,4-butandiol bisglycidyl ether or diglycidyl ether; and
in step c) at least 20 mol of ethylene oxide and optionally at least 20 mol of propylene oxide is employed per mol of NH- and OH-functionality of second intermediate (I2); or
(9) in step b) the di- or oligoamine (A) is pentaethylenhexamine (PEHA) and the compound comprising at least two glycidyl ether groups is 1,4-butandiol bisglycidyl ether or ethylene glycol bisglycidyl ether; and
in step c) at least 25 mol of ethylene oxide and optionally at least 24 mol of propylene oxide is employed per mol of NH- and OH-functionality of second intermediate (I2).

12. A process to prepare an alkoxylated nitrogen containing polymer comprising carrying out the process steps according to claim 1.

13. A compound that is the second intermediate (I2) in step b) according to claim 1.

14. A method of using the alkoxylated nitrogen containing polymer according to claim 1, the method comprising using the alkoxylated nitrogen containing polymer in cleaning compositions, in fabric and home care products, in cosmetic formulations, as a crude oil emulsion breaker, in pigment dispersions for ink jet inks, in formulations for electro plating, in cementitious compositions, as a dispersant for agrochemical formulations and/or as an additive for the papermaking industry.

15. The method according to claim 14, comprising using the alkoxylated nitrogen containing polymer in cleaning compositions and/or in fabric and home care products for
i) clay removal, and/or
ii) improved removal of oily/fatty stains, and/or
iii) soil removal of particulate stains, and/or
iv) dispersion and/or emulsification of soils, and/or
v) modification of treated surface to improve removal upon later re-soiling, and/or
vi) whiteness improvement and/or
vii) —when at least one enzyme selected from the list consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types, additionally for improvement of removal of oily/fatty stains, food stain removal and/or removal of complex stains.

16. A method of using a compound that is the second intermediate (I2) in step b) according to claim 1, the method comprising using the compound in solid automatic dish wash compositions, for preventing the corrosion of glass.

17. Cleaning A cleaning composition, fabric and home care product, industrial and institutional cleaning product, cosmetic formulation, crude oil emulsion breaker, pigment dispersion for ink jet inks, formulation for electro plating, cementitious composition, dispersant for agrochemical formulations, papermaking solutions and/or paper coatings, comprising at least one alkoxylated nitrogen containing polymer according to claim 1.

18. The cleaning composition according to claim 17 in a liquid laundry detergent formulation and/or a liquid manual dish wash detergent formulation comprising
a) the at least one alkoxylated nitrogen containing polymer according to claim 1;
b) at least one anionic surfactant; and
c) water.

19. A cleaning composition in a solid automatic dish wash formulation comprising
a) a compound that is the second intermediate (I2) in step b) according to claim 1, and
b) at least one chelating agent selected from the group consisting of methylglycinediaceticacid (MGDA), glutamic acid diacetate (GLDA), citric acid and salts thereof.

20. The cleaning composition according to claim 17 further comprising at least one enzyme selected from the group consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types.

21. The composition according to claim 17 further comprising an antimicrobial agent selected from the group consisting of 2-phenoxyethanol and 4,4′-dichoro 2-hydroxydiphenylether.
